(19) United States
(12) Patent Application Publication
(10) Pub. No.: US 2026/0015469 A1
(43) Pub. Date: Jan. 15, 2026

(54) HEAT-RESISTANT SILANE CROSSLINKED RESIN FORMED BODY, SILANE CROSSLINKABLE RESIN COMPOSITION, METHOD OF PRODUCING SAME, AND WIRING MATERIAL

(71) Applicant: FURUKAWA ELECTRIC CO., LTD., Tokyo (JP)

(72) Inventors: Hiroki ASHIKAWA, Tokyo (JP); Hiroki CHIBA, Tokyo (JP); Masaki NISHIGUCHI, Tokyo (JP)

(73) Assignee: FURUKAWA ELECTRIC CO., LTD., Tokyo (JP)

(21) Appl. No.: 19/332,900

(22) Filed: Sep. 18, 2025

Related U.S. Application Data
(63) Continuation of application No. PCT/JP2023/011212, filed on Mar. 22, 2023.

(51) Int. Cl. C08J 3/22; C08J 3/20; C08J 3/24; C08K 3/22; C08K 5/134; C08K 5/14; C08K 5/3447

(52) U.S. Cl. CPC C08J 3/226; C08J 3/203; C08J 3/247; C08K 5/134; C08K 5/14; C08K 5/3447; C08J 2323/08; C08J 2323/12; C08J 2423/16; C08J 2453/02; C08J 2491/00; C08K 2003/2227

(57) ABSTRACT

Provided are a silane crosslinkable resin composition which contains, with respect to a base resin containing at least one ethylene copolymer of an ethylene-vinyl acetate copolymer or an ethylene-(meth)acrylic acid ester copolymer, boehmite, a silane coupling agent part, and a silanol condensation catalyst at a specific ratio, and contains a hindered phenol-based antioxidant and a benzimidazole-based antioxidant, but does not contain aluminum hydroxide, a heat-resistant silane crosslinked resin formed body using the same, a method of producing the same, and further a wiring material having a coating layer formed of the heat-resistant silane crosslinked resin formed body.

### CROSS-REFERENCE TO RELATED APPLICATIONS

This application is a Continuation of PCT International Application No. PCT/JP2023/011212 filed on Mar. 22, 2023. The above application is hereby expressly incorporated by reference, in its entirety, into the present application.

### FIELD OF THE INVENTION

The present invention relates to a heat-resistant silane crosslinked resin formed body, a silane crosslinkable resin composition, a method of producing the same, and a wiring material using the heat-resistant silane crosslinked resin formed body.

### BACKGROUND OF THE INVENTION

Wiring materials, such as insulated wires, cables, cords, optical fiber core wires or optical fiber cords (optical fiber cables), each of which can be used in an electrical- or electronic-equipment field, and an industrial field, are required to have, for example, heat resistance in terms of safety and reliability.

In recent years, higher performance and higher functionality of electrical- or electronic-equipment and the like have progressed, and higher heat resistance has been required for wiring materials used for these devices. For example, wiring materials for automobiles (particularly cables and crosslinked electric wires mounted in engine rooms of automobiles) are required to have a very high heat-resistant temperature. Specifically, the wiring materials are required to meet the standard, specified in the Japanese Automotive Standards Organization (JASO), that tensile elongation after a lapse of 10000 hours at 150° C. is 100% or more (elongation percentage is 100% or more) in a heat resistance test (aging resistance test).

Examples of the wiring materials satisfying such high heat resistance include wiring materials in which an insulating coating layer provided around a conductor is conventionally formed of a composition containing silicone, fluororubber, fluororesin, or the like as a base material. However, silicone materials have a problem in resistance to oils and solvents, and are not suitable for applications that may come into contact with engine oils and battery liquids. In addition, the fluororubber and the fluororesin are very expensive, have a high material density, and have a large mass of wiring material, and thus are not suitable for the wiring material required to be reduced in weight and cost.

In view of the above problems, a method of producing a wiring material (crosslinked electric wire) excellent in heat resistance through formation of a coating layer by crosslinking an inexpensive and lightweight polyolefin resin as a base material has been developed.

For example, Patent Literature 1 recites a method of producing a non-halogen insulated wire by electronic beam irradiation crosslinking a resin composition containing a sulfur-based antioxidant, a hindered phenol-based antioxidant, a metal hydroxide, and zinc oxide on a base resin containing polyethylene or the like as a main component.

Also, Patent Literature 2 recites, as a method of producing a heat-resistant silane crosslinked resin formed body for forming a coating layer of a wiring material, a method of silane-crosslinking a crosslinkable resin formed body containing a base resin, an organic peroxide, a metal hydrate, a bromine-based flame retardant, antimony trioxide, a silane coupling agent, and a silanol condensation catalyst at a specific ratio.

Furthermore, Patent Literature 3 recites, as a method of producing a flame-retardant crosslinked resin formed body for forming a coating layer of a wiring material, a method of silane-crosslinking a flame-retardant crosslinkable resin composition containing a base resin containing a specific resin component such as ethylene rubber, an organic peroxide, boehmite, a silane coupling agent, and a silanol condensation catalyst at a specific ratio.

### CITATION LIST

### Patent Literature

Patent Literature 1: JP-A-2007-207642 (“JP-A” means an unexamined published Japanese patent application)
Patent Literature 2: JP-A-2016-121203
Patent Literature 3: JP-A-2017-179235

### SUMMARY OF THE INVENTION

### Technical Problem

In order to achieve high heat resistance at 150° C. for 10000 hours in the production method described in Patent Literature 1, it is necessary to use aluminum hydroxide or a complex thereof as a metal hydroxide in combination with 2-mercaptobenzimidazole as a sulfur-based antioxidant, in addition to the hindered phenol-based antioxidant and zinc oxide. However, in a case where a large amount of aluminum hydroxide is used, the resin composition is easily foamed in the melt-mixing step or the forming step, and it is not possible to produce a coating layer (wiring material) having a predetermined appearance. In particular, in the silane crosslinking method in which it is necessary to execute the melt-mixing step and the forming step under a higher temperature condition with respect to the electronic beam irradiation crosslinking method, an appearance defect due to a decrease in surface smoothness of the formed body (appearance roughness) and generation of lumps (aggregates) (generation of apparent lumps) are likely to occur. Further, unless production conditions such as melt-mixing conditions and forming conditions are strictly controlled, foaming remarkably occurs.

In addition, the heat-resistant silane crosslinked resin formed body or the flame-retardant crosslinked resin formed body produced by the production methods described in Patent Literatures 2 and 3 exhibits a certain degree of heat resistance. However, there is room for further study in order to achieve both excellent appearance and high heat resistance.

The present invention provides a heat-resistant silane crosslinked resin formed body which solves the above problems, exhibits high heat resistance of, for example, 150° C. or higher even though the polyolefin resin is used, and has a smooth surface and excellent appearance characteristics without lumps and foaming, and a method of capable of producing the formed body while suppressing foaming. The present invention also provides a silane crosslinkable resin composition capable of forming the heat-resistant silane crosslinked resin formed body, and a method of producing the same. Further, the present invention provides a wiring material including a heat-resistant silane crosslinked resin formed body obtained by the method of producing the heat-resistant silane crosslinked resin formed body as a coating layer.

### Solution to Problem

The present inventors have found that in a silane crosslinking method using a base resin containing a polyolefin resin as an essential component, the use of a silane crosslinkable resin composition prepared by a specific step so as to contain a specific ethylene copolymer as a polyolefin resin, boehmite as an inorganic filler, and two kinds of antioxidants: a hindered phenol-based antioxidant and a benzimidazole-based antioxidant in specific contents and avoiding the content of aluminum hydroxide as an inorganic filler makes it possible to form a silane crosslinked resin formed body in which the occurrence of lumps and foaming can be suppressed in a melt-mixing step and a forming step and which has a smooth surface and exhibits high heat resistance. The present inventors repeated more studies based on these findings and finally completed the present invention.

That is, the above-described problems of the present invention are solved by the following means.

<1> A method of producing a heat-resistant silane crosslinked resin formed body including subjecting a silane crosslinkable resin composition to silane crosslinking, wherein the silane crosslinkable resin composition contains, with respect to 100 parts by mass of a base resin containing at least one ethylene copolymer of an ethylene-vinyl acetate copolymer or an ethylene-(meth)acrylic acid ester copolymer, 9 to 80 parts by mass of boehmite, 1 to 15 parts by mass of a silane coupling agent graft-bonded to the base resin, 0.01 to 0.5 parts by mass of a silanol condensation catalyst, a hindered phenol-based antioxidant, and a benzimidazole-based antioxidant, but does not contain aluminum hydroxide,
the method including the following steps (a), (b), (c), (d), and (e), wherein the hindered phenol-based antioxidant or the benzimidazole-based antioxidant is mixed in at least one of the steps (a) and (b):
Step (a): a step of preparing a silane masterbatch by melt-mixing a part of the base resin, the boehmite, the silane coupling agent having a grafting reaction site capable of being graft-reacted with the base resin, and 0.01 to 0.5 parts by mass of an organic peroxide with respect to 100 mass % of the base resin at a temperature equal to or higher than a decomposition temperature of the organic peroxide;
Step (b): a step of preparing a catalyst masterbatch by melt-mixing a remainder of the base resin and the silanol condensation catalyst;
Step (c): a step of obtaining a silane crosslinkable resin composition by dry blending the silane masterbatch and the catalyst masterbatch;
Step (d): a step of obtaining a formed body by forming the silane crosslinkable resin composition; and
Step (e): a step of obtaining a heat-resistant silane crosslinked resin formed body by bringing the formed body and water into contact with each other.

<2> The production method according to <1>, wherein the hindered phenol-based antioxidant is contained in an amount of 0.5 to 5 parts by mass with respect to 100 parts by mass of the base resin.

<3> The production method according to <1> or <2>, wherein the benzimidazole-based antioxidant is contained in an amount of 4 to 12 parts by mass with respect to 100 parts by mass of the base resin.

<4> The production method according to any one of <1> to <3>, wherein the ethylene copolymer is contained in a proportion of 10 to 70 mass % in 100 mass % of the base resin.

<5> The production method according to any one of <1> to <4>, wherein each of the ethylene copolymers contained in the base resin contains vinyl acetate or (meth)acrylic acid ester in a proportion of 10 to 30 mass % in each of the ethylene copolymers.

<6> The production method according to any one of <1> to <5>, wherein the boehmite is contained in an amount of 9 to 50 parts by mass with respect to 100 parts by mass of the base resin.

<7> The production method according to any one of <1> to <6>, wherein the base resin contains a styrene-based elastomer and an organic oil.

<8> A method of producing a silane crosslinkable resin composition, wherein the silane crosslinkable resin composition contains, with respect to 100 parts by mass of a base resin containing at least one ethylene copolymer of an ethylene-vinyl acetate copolymer or an ethylene-(meth)acrylic acid ester copolymer, 9 to 80 parts by mass of boehmite, 1 to 15 parts by mass of a silane coupling agent graft-bonded to the base resin, 0.01 to 0.5 parts by mass of a silanol condensation catalyst, a hindered phenol-based antioxidant, and a benzimidazole-based antioxidant, but does not contain aluminum hydroxide,
the method including the following steps (a), (b), and (c), wherein the hindered phenol-based antioxidant or the benzimidazole-based antioxidant is mixed in at least one of the steps (a) and (b):
Step (a): a step of preparing a silane masterbatch by melt-mixing a part of the base resin, the boehmite, the silane coupling agent having a grafting reaction site capable of being graft-reacted with the base resin, and 0.01 to 0.5 parts by mass of an organic peroxide with respect to 100 mass % of the base resin at a temperature equal to or higher than a decomposition temperature of the organic peroxide;
Step (b): a step of preparing a catalyst masterbatch by melt-mixing a remainder of the base resin and the silanol condensation catalyst; and
Step (c): a step of obtaining a silane crosslinkable resin composition by dry blending the silane masterbatch and the catalyst masterbatch.

<9> A heat-resistant silane crosslinked resin formed body produced by the production method described in any one of <1> to <7>.

<10> A silane crosslinkable resin composition produced by the production method described in <8>.

<11> A wiring material including a coating layer on an outer periphery of a conductor, wherein the coating layer is a layer of the heat-resistant silane crosslinked resin formed body described in <9>.

<12> The wiring material according to <11>, wherein the wiring material is a heat-resistant electric wire or cable.

In the present invention, in a case where the content, physical properties, and the like of components are described by referring to numerical ranges, when the upper limit and the lower limit of a numerical range is separately described, any of the upper limit thereof and any of the the lower limit thereof can be appropriately combined to set a specific numerical range. Meanwhile, when a numerical range is described using “to”, the numerical range expressed by using the expression “to” means a range including numerical values before and after the expression “to” as the lower limit and the upper limit. On the other hand, in a case where a plurality of numerical ranges expressed with the term “to” is set and described, the upper limit and the lower limit forming a numerical range are not limited to a specific combination of the upper limit and the lower limit described before and after the term “to” as a specific numerical range, and may be a numerical range in which the upper limit and the lower limit of each of the numerical ranges are appropriately combined.

### Advantageous Effects of Invention

The present invention can provide a heat-resistant silane crosslinked resin formed body that exhibits high heat resistance of, for example, 150° C. or higher even though the polyolefin resin is used, and has a smooth surface and excellent appearance characteristics without lumps and foaming, and provide a method of capable of producing the formed body while suppressing foaming. The present invention also can provide a silane crosslinkable resin composition capable of forming the heat-resistant silane crosslinked resin formed body, and a method of producing the same. Further, the present invention can provide a wiring material including a heat-resistant silane crosslinked resin formed body obtained by the method of producing the heat-resistant silane crosslinked resin formed body as a coating layer.

The above-described and other features and advantages of the present invention will appear more fully from the following description.

### DESCRIPTION OF EMBODIMENTS

### [Heat-Resistant Silane Crosslinked Resin Formed Body]

The heat-resistant silane crosslinked resin formed body of the present invention is a crosslinked resin formed body (a formed body formed of a silanol condensate of a silane crosslinkable resin composition) obtained by forming a silane crosslinkable resin composition described later and then subjecting the silane crosslinkable resin composition to silane crosslinking (silanol condensation reaction). The heat-resistant silane crosslinked resin formed body of the present invention can be produced while suppressing the occurrence of a cause of appearance defect, particularly generation of lumps and foaming, and the formed body has a smooth surface and excellent appearance without lumps and foaming. In the present invention, when foaming occurs, bubbles (cavities) are mainly generated in the formed body, leading to deterioration of the characteristics of the formed body, but the presence or absence of the bubbles due to foaming is also regarded as one of the appearance characteristics of the formed body.

The heat-resistant silane crosslinked resin formed body of the present invention not only exhibits the excellent appearance described above, but also can realize high heat resistance of, for example, 150° C. or higher, specifically high heat resistance enough to satisfy a heat resistance test regarding tensile elongation after a lapse of 10000 hours at 150° C. defined by JASO, even though the heat-resistant silane crosslinked resin formed body contains the polyolefin resin. Details of the heat resistance test will be described in the section of Examples.

Although details will be described later, this heat-resistant silane crosslinked resin formed body has a crosslinked structure in which a base resin, ordinarily at least one ethylene copolymer of an ethylene-vinyl acetate copolymer or an ethylene-(meth)acrylic acid ester copolymer, is silane-crosslinked (crosslinked structure via a silane coupling agent or a silanol condensate thereof). In this crosslinked structure, as described later, boehmite, and further an inorganic filler to be contained as appropriate may be incorporated. It is preferable that boehmite is incorporated in a part of the crosslinked structure.

The heat-resistant silane crosslinked resin formed body of the present invention does not contain aluminum hydroxide, a bromine-based flame retardant, and further zinc oxide. Even when these components are not contained, the above-mentioned excellent characteristics are exhibited. The phrase “the heat-resistant silane crosslinked resin formed body does not contain the components” has the same meaning as that in the silane crosslinkable resin composition described later.

The heat-resistant silane crosslinked resin formed body of the present invention is used for a product (including a semi-finished product, a part, and a member) required to have heat resistance. Examples of such a product include, for example, various wiring materials, heat-resistant sheets, and heat-resistant films. In addition, examples thereof include plugs for power supply, connectors, sleeves, boxes, tape base materials, tubes, sheets, packings, cushion materials, and vibration-proof materials. In particular, the heat-resistant silane crosslinked resin formed body is suitably used as a wiring material for an automobile which is required to have high heat resistance, particularly as a material of an insulating coating layer of a cable or a crosslinked electric wire mounted in an engine room of an automobile.

### [Silane Crosslinkable Resin Composition]

The silane crosslinkable resin composition of the present invention contains, with respect to 100 parts by mass of a base resin containing at least one ethylene copolymer of an ethylene-vinyl acetate copolymer or an ethylene-(meth)acrylic acid ester copolymer, 9 to 80 parts by mass of boehmite, 1 to 15 parts by mass of a silane coupling agent graft-bonded to the base resin, 0.01 to 0.5 parts by mass of a silanol condensation catalyst, a hindered phenol-based antioxidant, and a benzimidazole-based antioxidant, but does not contain aluminum hydroxide. This silane crosslinkable resin composition is a composition (a dry-blended product) prepared by the method of producing a silane crosslinkable resin composition of the present invention described later.

As will be described in detail later, the silane crosslinkable resin composition of the present invention contains boehmite, and further contains a silane crosslinkable resin in which a silane coupling agent bonded to or dissociated from an inorganic filler to be contained as appropriate is graft-reacted with (graft-bonded to) a base resin, particularly an ethylene copolymer. The use of this silane crosslinkable resin composition makes it possible to produce the above-described heat-resistant silane crosslinked resin formed body exhibiting excellent characteristics by a silane crosslinking method (silanol condensation reaction) while suppressing volatilization of the silane coupling agent, foaming during melt-mixing, and the like. The silane crosslinkable resin composition is suitably used in the method of producing a heat-resistant silane crosslinked resin formed body of the present invention.

The silane crosslinkable resin composition of the present invention contains boehmite as an inorganic filler, but does not contain aluminum hydroxide. Thus, foaming in the step of preparing the silane crosslinkable resin composition and the forming step can be effectively suppressed without impairing the expression of high heat resistance of the heat-resistant silane crosslinked resin formed body, and the appearance characteristics can be improved. In the present invention, the phrase “the composition does not contain aluminum hydroxide” encompasses an aspect in which the content of aluminum hydroxide is 0 parts by mass with respect to 100 parts by mass of the base resin in the composition, and an aspect in which aluminum hydroxide is contained at a certain content. The content in this case cannot be uniquely determined because the effect of suppressing foaming varies depending on adjustment of production conditions or the like. For example, the content is preferably 10 parts by mass or less, more preferably 5 parts by mass or less, and still more preferably 3 parts by mass or less, with respect to 100 parts by mass of the base resin in the composition.

In the present invention, the term “aluminum hydroxide” contained in the composition encompasses aluminum hydroxide used as an arbitrary inorganic filler as well as aluminum hydroxide remaining or mixed in the boehmite as described later.

In one of preferable aspects, the silane crosslinkable resin composition of the present invention does not contain a bromine-based flame retardant. In this aspect, a non-halogen resin formed body can be obtained without impairing the expression of high heat resistance of the heat-resistant silane crosslinked resin formed body. The bromine-based flame retardant is not particularly limited, and is, for example, a bromine-based flame retardant described in Patent Literature 2. In the present invention, the phrase that “the composition does not contain a bromine-based flame retardant” encompasses an aspect in which the content of the bromine-based flame retardant is 10 parts by mass or less, in addition to an aspect in which the content of the bromine-based flame retardant is 0 parts by mass, with respect to 100 parts by mass of the base resin in the composition. The content is preferably 5 parts by mass or less.

In one of preferred aspects, the silane crosslinkable resin composition of the present invention does not contain zinc oxide. In the present invention, the phrase that the composition does not contain zinc oxide encompasses an aspect in which the content of zinc oxide is 5 parts by mass or less, in addition to an aspect in which the content of zinc oxide is 0 parts by mass, with respect to 100 parts by mass of the base resin in the composition. The content is preferably 3 parts by mass or less.

Hereinafter, each component to be used in the present invention will be explained.

One kind or two or more kinds of each component can be used.

### <Base Resin>

The base resin used in the present invention may contain at least one ethylene copolymer of an ethylene-vinyl acetate copolymer or an ethylene-(meth)acrylic acid ester copolymer. When the base resin contains an ethylene copolymer, the use of boehmite in combination with two kinds of antioxidants makes it possible to form a silane crosslinked resin formed body exhibiting high heat resistance.

The base resin may contain a polyolefin resin, further may contain a rubber or elastomer such as a polymer that forms the polyolefin resin, and further contain an organic oil and the like, in addition to the ethylene copolymer. Among these materials, it is preferable to contain at least one of polyethylene, polypropylene, ethylene rubber, styrene-based elastomer, or organic oil. It is more preferable to contain styrene-based elastomer and organic oil. It is still more preferable to contain a styrene-based elastomer and an organic oil, and at least one of polyethylene, polypropylene, or ethylene rubber. It is particularly preferable to contain polyethylene, polypropylene, ethylene rubber, styrene-based elastomer, and organic oil.

Each resin component forming the base resin ordinarily has, in a main chain or at the end thereof, a site capable of grafting reaction with a grafting reaction site of a silane coupling agent, for example, an unsaturated bond site of the carbon chain or a carbon atom having a hydrogen atom. However, in the present invention, since an ethylene copolymer having a site capable of grafting reaction is used, a resin component not having a site capable of grafting reaction can also be used as a resin component other than the ethylene copolymer.

### (Ethylene Copolymer)

The ethylene copolymer is, for example, at least one selected from the group consisting of an ethylene-vinyl acetate copolymer (EVA) and an ethylene-(meth)acrylic acid ester copolymer, and is more preferably an ethylene-vinyl acetate copolymer. The use of the ethylene copolymer in combination with boehmite and an antioxidant described later makes it possible to produce a silane crosslinked resin formed body exhibiting high heat resistance and excellent appearance characteristics. The number of ethylene copolymers contained in the base resin may be two or more, and may be two to three, and is preferably one or two. As the two or more kinds of ethylene copolymers, EVA or an ethylene-(meth)acrylic acid ester copolymer may be used in combination, or EVA and an ethylene-(meth)acrylic acid ester copolymer may be combined.

### —Ethylene-Vinyl Acetate Copolymer Resin—

As long as the ethylene-vinyl acetate copolymer is a copolymer of ethylene and vinyl acetate, the ethylene-vinyl acetate copolymer may be an alternating copolymer obtained by alternately polymerizing an ethylene component and a vinyl acetate component, may be a block copolymer obtained by bonding a polymerization block of an ethylene component and a polymerization block of a vinyl acetate component, or may be a random copolymer obtained by randomly polymerizing an ethylene component and a vinyl acetate component.

The content (EV content) of the vinyl acetate component in each ethylene-vinyl acetate copolymer used as the base resin is not particularly limited, and can be appropriately set. The content of the vinyl acetate component is preferably 10 to 30 mass %, more preferably 15 to 25 mass %, from the viewpoint of being able to produce a formed body having excellent appearance characteristics and exhibiting high heat resistance. When a plurality of ethylene-vinyl acetate copolymers is used, the content of the vinyl acetate component in the entire ethylene-vinyl acetate copolymer is not particularly limited, and can be appropriately set. The content of vinyl acetate can be determined in accordance with Japanese Industrial Standards (JIS) K 7192.

### —Ethylene-(Meth)Acrylic Acid Ester Copolymer—

As long as the ethylene-(meth)acrylic acid ester copolymer is a copolymer of ethylene and (meth)acrylic acid ester, the ethylene-(meth)acrylic acid ester copolymer may be any of an alternating copolymer, a block copolymer, and a random copolymer, similarly to the ethylene-vinyl acetate copolymer described above. The (meth)acrylic acid ester is not particularly limited, and an alkyl (meth)acrylate ester is preferable. The number of carbons of the alkyl group is preferably 1 to 12, more preferably 1 to 4. Examples of the ethylene-(meth)acrylic acid ester copolymer include an ethylene-methyl (meth)acrylate copolymer (EMA), an ethylene-ethyl (meth)acrylate copolymer (EEA), and an ethylene-butyl (meth)acrylate copolymer (EBA).

The content (EA content) of the (meth)acrylic acid ester component in each ethylene-(meth)acrylic acid ester copolymer used as the base resin is not particularly limited, and can be appropriately set. The content of the (meth)acrylic acid ester component is preferably 10 to 30 mass %, more preferably 15 to 25 mass %, from the viewpoint that generation of lumps can be effectively suppressed to form a formed body excellent in appearance characteristics. When a plurality of ethylene-(meth)acrylic acid ester copolymers is used, the content of the (meth)acrylic acid ester component in the entire ethylene-(meth)acrylic acid ester copolymer is not particularly limited, and can be appropriately set. In the case of a product, the content of (meth)acrylic acid ester can be grasped from the polymerization amount and the like at the time of production, whereas in the case of a commercially available product, a value described in the document (such as catalogue or product information) of the manufacturer or the seller can be employed.

### (Polyolefin Resin)

The polyolefin resin is not particularly limited as long as it is a resin including a polymer obtained by homopolymerizing or copolymerizing a compound having an ethylenically unsaturated bond, and known resins conventionally used in heat-resistant resin compositions can be used.

Examples thereof include polyethylene (PE), polypropylene (PP), an ethylene-α-olefin copolymer, and a polyolefin copolymer including an acid copolymerized component or an acid ester copolymerized component (excluding the above-described ethylene copolymer).

The polyethylene (PE) is not particularly limited as long as it is a polymer including an ethylene component as a main component. Examples thereof include high-density polyethylene (HDPE), low-density polyethylene (LDPE), ultrahigh molecular weight polyethylene (UHMW-PE), linear low-density polyethylene (LLDPE), and very low density polyethylene (VLDPE).

The polypropylene (PP) is not particularly limited as long as it is a polymer including a propylene component as a main component. Examples thereof include random polypropylene and block polypropylene, in addition to a homopolymer of propylene.

The ethylene-α-olefin copolymer is preferably a copolymer of ethylene and an α-olefin with carbon number of 3 to 12 (excluding those included in polyethylene and polypropylene). Examples thereof include an ethylene-propylene copolymer (excluding those included in polypropylene), an ethylene-butylene copolymer, and an ethylene-α-olefin copolymer synthesized in the presence of a single-site catalyst.

The compound that leads an acid copolymerized component or an acid ester copolymerized component in the polyolefin copolymer having the acid copolymerized component or the acid ester copolymerized component is not particularly limited, and examples thereof include carboxylic acid compounds such as (meth)acrylic acid. Examples of the polyolefin copolymer having the acid copolymerized component or the acid ester copolymerized component include, for example, an ethylene-(meth)acrylic acid copolymer.

The polyolefin resin may be acid-modified with an ordinarily used unsaturated carboxylic acid, a derivative thereof, or the like.

### (Rubber or Elastomer)

The rubber or elastomer is not particularly limited, and for example, an ethylene rubber or a styrene-based elastomer is preferable.

### —Ethylene Rubber—

The ethylene rubber is not particularly limited as long as it is a rubber of a copolymer obtained by copolymerizing a compound having an ethylenically unsaturated bond, and a known ethylene rubber can be used. Preferably, the ethylene rubber includes binary copolymer rubber of ethylene and α-olefin, a ternary copolymer rubber of ethylene, α-olefin, and diene compound, and the like. The α-olefin is not particularly limited, and α-olefins with carbon number of 3 to 12 and the like are preferable. Further, the diene compound constituting the ternary copolymer is not particularly limited, and examples thereof include conjugated diene compounds such as butadiene, isoprene, 1,3-pentadiene and 2,3-dimethyl-1,3-butadiene, and non-conjugated diene compounds such as dicyclopentadiene (DCPD), ethylidene norbornene (ENB) and 1,4-hexadiene. Non-conjugated diene compounds are preferable. As the binary copolymer rubber, an ethylene-propylene rubber (EPM) is preferable. As the ternary copolymer, an ethylene-propylene-diene rubber (EPDM) is preferable.

### —Styrene-Based Elastomer—

The styrene-based elastomer refers to an elastomer including a polymer having a constituent derived from an aromatic vinyl compound in a molecule. Examples of the styrene-based elastomer include block and random copolymers of a conjugated diene compound and an aromatic vinyl compound, or hydrogenated products thereof. Specific examples thereof include styrene-ethylene-butylene-styrene block copolymer (SEBS), styrene-isoprene-styrene block copolymer (SIS), hydrogenated SIS, styrene-butadiene-styrene block copolymer (SBS), hydrogenated SBS, styrene-ethylene-ethylene-propylene-styrene block copolymer (SEEPS), styrene-ethylene-propylene-styrene block copolymer (SEPS), styrene-butadiene rubber (SBR), and hydrogenated styrene-butadiene rubber (HSBR).

### (Organic Oil)

The base resin may contain various oils, and preferably contains, particularly together with an elastomer. The base resin contains an elastomer and an organic oil, as a result of which the formability of the silane crosslinkable resin composition is improved, and an improvement in appearance characteristics can be enhanced. Examples of such an oil include an oil as a plasticizer used for a polyolefin resin or a mineral oil softener for rubber. The mineral oil softener is a mixed oil including three oils: an oil containing a hydrocarbon having an aromatic ring, an oil containing a hydrocarbon having a naphthene ring, and an oil containing a hydrocarbon having a paraffin chain. Among the oils, the paraffin oil and the naphthene oil are suitably used. In particular, the paraffin oil is suitably used.

### (Composition of Base Resin)

The total content rate of the ethylene copolymer in 100 mass % of the base resin is not particularly limited, and can be 5 to 85 mass %. The total content rate is preferably 10 to 70 mass %, more preferably 15 to 50 mass %, and still more preferably 20 to 40 mass %, from the viewpoint of achieving both appearance characteristics and heat resistance.

The total content rate of the polyolefin resin in 100 mass % of the base resin is not particularly limited, and is preferably 10 to 70 mass %, more preferably 15 to 50 mass %, and still more preferably 20 to 40 mass %, from the viewpoint of achieving both appearance characteristics and heat resistance.

The content rate of polyethylene in 100 mass % of the base resin is not particularly limited, and is appropriately set in consideration of the total content of the polyolefin resin. For example, the content rate is preferably 10 to 70 mass %, more preferably 15 to 40 mass %. Similarly, the content rate of the polypropylene in 100 mass % of the base resin is not particularly limited, and is appropriately set in consideration of the total content of the polyolefin resin. For example, the content rate is preferably 3 to 20 mass %, more preferably 5 to 15 mass %. The content rate of the ethylene-α-olefin copolymer and the polyolefin copolymer having an acid copolymerized component or an acid ester copolymerized component in 100 mass % of the base resin is not particularly limited, and is appropriately set in consideration of the total content of the polyolefin resin. For example, the content rate of each of the copolymers can be 0 to 20 mass %.

The content rate of the rubber in 100 mass % of the base resin is not particularly limited, and is preferably 0 to 40 mass %, more preferably 5 to 30 mass %, and still more preferably 10 to 20 mass %, from the viewpoint of enhancing an improvement in appearance characteristics, particularly increasing the viscosity of the material to suppress foaming. The content rate of the elastomer in 100 mass % of the base resin is not particularly limited, and is preferably 0 to 40 mass %, more preferably 5 to 30 mass %, and still more preferably 10 to 20 mass % from the viewpoint of formability of the silane crosslinkable resin composition.

The content rate of the organic oil in 100 mass % of the base resin is not particularly limited. For example, the content rate is preferably 0 to 30 mass %, more preferably 5 to 20 mass %, from the viewpoint of formability of the silane crosslinkable resin composition. When the base resin contains the elastomer and the organic oil, the total content of the elastomer and the organic oil is appropriately determined according to each content. For example, the total content is preferably more than 0 parts by mass and 50 mass % or less, more preferably 10 to 30 mass %.

### <Boehmite>

Boehmite used in the present invention is aluminum oxide hydrate (Al₂O₃·H₂O). The boehmite acts as a filler or a flame retardant. From the viewpoint of retaining the silane coupling agent and contributing to improvement of mechanical characteristics and heat resistance, the boehmite preferably has, on its surface, a site (e.g. an oxygen atom) that can be chemically bonded to a silanol condensable reaction site of the silane coupling agent by a hydrogen bond, a covalent bond, or the like, or an intermolecular bond.

Ordinarily, boehmite can be synthesized by a hydrothermal treatment of aluminum hydroxide, and a commercially available product can also be used. In addition to the boehmite formed of aluminum oxide hydrate after completion of the hydrothermal treatment, a composite with aluminum hydroxide obtained by stopping the hydrothermal treatment reaction in the middle of the reaction can also be used as the boehmite used in the present invention. However, in the present invention, the content of aluminum hydroxide in each of the silane crosslinkable resin composition and the heat-resistant silane crosslinked resin formed body is set to a range satisfying the above range. In the present invention, depending on the presence or absence and the amount of aluminum hydroxide used as the inorganic filler, the amount of aluminum hydroxide present in the boehmite (composite) is appropriately determined in consideration of the permissible content of aluminum hydroxide in the heat-resistant silane crosslinked resin formed body. The amount of aluminum hydroxide, for example, as the measured value in the “Method of measuring content of aluminum hydroxide” section in Examples described later, is preferably 0 to 15 mass %, more preferably 0 to 10 mass %.

The boehmite may or need not be surface-treated. In addition, the boehmite is preferably in the form of particles. As the surface treatment agent for boehmite, the surface treatment agent for the inorganic filler can be used without particular limitation, and examples thereof include various fatty acids and various coupling agents such as a silane coupling agent. The amount of surface treatment of boehmite is not particularly limited, and is, for example, 3 mass % or less.

### <Silane Coupling Agent>

The silane crosslinkable resin composition contains a silane coupling agent graft-bonded to a base resin. The base resin to which the silane coupling agent is graft-bonded is preferably prepared by a grafting reaction between the silane coupling agent and the base resin in the step (a) as described later.

The silane coupling agent (before the grafting reaction) used in the present invention has a grafting reaction site (as an atom, or a functional group such an ethylenically unsaturated group or the like) capable of being graft-reacted with a grafting reactive site of the base resin, in the presence of radical generated by decomposition of organic peroxide. Further, the silane coupling agent has a hydrolyzable silyl group as the silanol condensable reaction site, and can preferably react with a site to which boehmite or an inorganic filler can be chemically bonded. The silane coupling agent that can be used in the present invention is not particularly limited, and examples thereof include silane coupling agents which have been used in the conventional silane crosslinking method.

Preferable examples of the silane coupling agent include silane coupling agents having an ethylenically unsaturated group and a hydrolyzable silyl group. Specific examples thereof include vinylalkoxysilane such as vinyltrimethoxysilane, vinyltriethoxysilane, vinyltributoxysilane, vinyldimethoxyethoxysilane, vinyldimethoxybutoxysilane, vinyldiethoxybutoxysilane, allyltrimethoxysilane, allyltriethoxysilane, and vinyltriacetoxysilane, and (meth)acryloxy alkoxysilane such as (meth)acryloxysilane such as methacryloxypropyltrimethoxysilane, methacryloxypropyltriethoxysilane, and methacryloxypropylmethyldimethoxysilane. Among these silane coupling agents, vinyltrimethoxysilane or vinyltriethoxysilane is particularly preferable.

### <Silanol Condensation Catalyst>

The silanol condensation catalyst is capable of causing a condensation reaction (acceleration), in the presence of water, of a silanol condensable reaction site of the silane coupling agent graft-bonded to the base resin. Due to the function of this silanol condensation catalyst, base resins are crosslinked through the silane coupling agent.

The forgoing silanol condensation catalyst is not particularly limited. Examples thereof include organic tin compounds, metal soaps, and platinum compounds. As the organic tin compounds, examples thereof include organic tin compounds, such as dibutyltin dilaurate, dioctyltin dilaurate, dibutyltin dioctylate, and dibutyltin diacetate.

### <Hindered Phenol-Based Antioxidant>

The hindered phenol-based antioxidant is not particularly limited as long as it is an antioxidant having a hindered phenol structure. Known hindered phenol-based antioxidants, for example, those ordinarily used in the field of wiring materials and the like can be used. Examples thereof include pentaerythritol tetrakis[3-(3,5-di-tert-butyl-4-hydroxyphenyl)propionate](trade name: IRGANOX 1010, manufactured by BASF), stearyl 3-(3,5-di-tert-butyl-4-hydroxyphenyl)propionate (trade name: IRGANOX 1076, manufactured by BASF), N,N′-bis[3-(3′,5′-di-t-butyl-4′-hydroxyphenyl)propionyl]hexamethylenediamine (IRGANOX 1098 (trade name), manufactured by BASF), and N,N′-bis[3-(3,5-di-t-butyl-4-hydroxyphenyl)propionyl]hydrazine (ADK STAB CDA-10 (trade name), manufactured by ADEKA CORPORATION).

### <Benzimidazole-Based Antioxidant>

The benzimidazole-based antioxidant is not particularly limited as long as it is an antioxidant having a benzimidazole structure. Known benzimidazole-based antioxidants, for example, those ordinarily used in the field of wiring materials and the like can be used. Examples thereof include 2-mercaptobenzimidazole or a zinc salt thereof (NOCRAC MBZ, trade name, 1,3-dihydro-2H-benzimidazole-2-thione, 0.5 zinc, manufactured by OUCHI SHINKO CHEMICAL INDUSTRIAL CO., LTD.), 2-methylmercaptobenzimidazole or a zinc salt thereof, and 1,3-dihydro-1-phenyl-2H-benzimidazole-2-thione or a zinc salt thereof.

<Inorganic Filler Other than Boehmite>

In the present invention, an inorganic filler other than boehmite may be used.

The inorganic filler preferably has, on its surface, a site (e.g. an OH group of hydroxyl group, water molecule in hydrous substance or crystallized water, carboxyl group or the like, an amino group, an SH group, or the like) that can chemically bonded to a silanol condensable reaction site of the silane coupling agent. For example, metal hydrate such as compound having a hydroxyl group or crystallized water, which includes aluminum hydroxide, magnesium hydroxide, calcium carbonate, magnesium carbonate, calcium silicate, magnesium silicate, calcium oxide, magnesium oxide, aluminum oxide, aluminum nitride, aluminum borate, whisker, hydrated aluminum silicate, hydrated magnesium silicate, basic magnesium carbonate, and hydrotalcite, and furthermore, boron nitride, silica (crystalline silica, amorphous silica, and the like), carbon, clay, zinc oxide, tin oxide, titanium oxide, molybdenum oxide, antimony trioxide, silicone compound, quartz, talc, zinc borate, white carbon, zinc borate, zinc hydroxystannate, or zinc stannate can be used. The inorganic filler may be surface-treated with a surface treatment agent.

### <Organic Peroxide>

In the present invention, an organic peroxide is used in the preparation of the silane crosslinkable resin composition.

The organic peroxide generates radicals by thermal decomposition, and functions to accelerate a grafting reaction of a silane coupling agent with the base resin (a covalent bond-forming reaction between a grafting reaction site of the silane coupling agent and a site capable of the grafting reaction of the base resin, and this is also referred to as a (radical) addition reaction). The organic peroxide is not particularly limited, and for example, compounds represented by formulas: R¹—OO—R², R³—OO—C(═O)R⁴, and R⁵C(═O)—OO(C═O)R⁶ are preferably used. Here, R¹ to R⁶ each independently represent an alkyl group, or an aryl group, or an acyl group. Among R¹ to R⁶ of each of the compounds, a compound in which all of R¹ to R⁶ are alkyl groups or a compound in which any one of R¹ to R⁶ is an alkyl group and the remainders are an acyl group is preferable.

As the decomposition temperature measured by the method described in Patent Literature 2, the decomposition temperature of the organic peroxide is preferably 80 to 195° C. and particularly preferably 125 to 180° C.

Examples of such an organic peroxide include an organic peroxide described in paragraph [0036] of Patent Literature 2, the contents of which are incorporated herein by reference. Among the organic peroxides, dicumyl peroxide, 2,5-dimethyl-2,5-di-(tert-butylperoxy)hexane (PERHEXA 25B), and 2,5-dimethyl-2,5-di-(tert-butylperoxy)hexyne-3 are preferable.

### <Additive>

In the present invention, various additives that are ordinarily used for electric wires, electric cables, electric cords, and the like can also be used. Examples of such an additive include a lubricant, a metal inactivator, a plasticizer, a flame retardant, a flame retardant aid, and (co)polymers other than those described for the base resin. Examples of the flame retardant (aid) include a bromine-based flame retardant and/or antimony trioxide.

### (Composition of Silane Crosslinkable Resin Composition)

The content of boehmite in the silane crosslinkable resin composition is not particularly limited, and is 9 to 80 parts by mass, preferably 9 to 50 parts by mass, and more preferably 20 to 40 parts by mass, with respect to 100 parts by mass of the base resin, from the viewpoint that both excellent appearance characteristics (surface smoothness) and high heat resistance can be achieved in a well-balanced manner, and further a sufficient crosslinked structure can be formed.

The content of the silane coupling agent graft-bonded to the base resin in the silane crosslinkable resin composition (content in terms of mass before being graft-reacted with the base resin) is not particularly limited, and is 1 to 15 parts by mass, preferably 2 to 10 parts by mass, and more preferably 2.5 to 6 parts by mass, with respect to 100 parts by mass of the base resin, from the viewpoint that a heat-resistant silane crosslinked resin formed body having a smooth surface and a sufficient crosslinked structure can be produced while suppressing the generation of aggregates (lumps) and the occurrence of foaming due to volatilization.

The content of the silanol condensation catalyst in the silane crosslinkable resin composition is not particularly limited, and is 0.01 to 0.5 parts by mass, preferably 0.03 to 0.2 parts by mass, and more preferably 0.05 to 0.15 parts by mass, with respect to 100 parts by mass of the base resin, from the viewpoint of being able to achieve both excellent appearance characteristics (suppression of generation of lumps) and high heat resistance in a well-balanced manner and further to realize excellent surface smoothness.

The content of the hindered phenol-based antioxidant in the silane crosslinkable resin composition is not particularly limited, and is preferably 0.2 to 8 parts by mass, more preferably 0.5 to 5 parts by mass, and still more preferably 1 to 3 parts by mass, with respect to 100 parts by mass of the base resin, from the viewpoint of being able to achieve high heat resistance and further to improve appearance characteristics (surface smoothness and suppression of generation of lumps).

The content of the benzimidazole-based antioxidant in the silane crosslinkable resin composition is not particularly limited, and is preferably 2 to 15 parts by mass, more preferably 4 to 12 parts by mass, and still more preferably 6 to 10 parts by mass, with respect to 100 parts by mass of the base resin, from the viewpoint of being able to achieve high heat resistance and further to improve appearance characteristics (surface smoothness and suppression of generation of lumps).

The content of the inorganic filler other than boehmite in the silane crosslinkable resin composition is not particularly limited, and can be appropriately set within a range not imparting the action and effect of the present invention. For example, the content is preferably 0 to 100 parts by mass, more preferably 0 to 50 parts by mass, with respect to 100 parts by mass of the base resin. However, when aluminum hydroxide is contained, the content is within the above range.

The content of the additive in the silane crosslinkable resin composition is not particularly limited, and can be appropriately set within a range not imparting the action and effect of the present invention. However, when the bromine-based flame retardant is contained, the content is preferably within the above range, and antimony trioxide may be contained or need not be contained.

### (Composition of Heat-Resistant Silane Crosslinked Resin Formed Body)

Since the heat-resistant silane crosslinked resin formed body is formed by forming a silane crosslinkable resin composition and then subjecting the silane crosslinkable resin composition to a silanol condensation reaction, the content of the respective components in the formed body is ordinarily the same as the content in the silane crosslinkable resin composition. However, in the heat-resistant silane crosslinked resin formed body, the content of the silane coupling agent is intended to the content before the silanol condensation reaction, and the content of the base resin is intended to the content before the crosslinking.

### [Method of Producing Heat-Resistant Silane Crosslinked Resin Formed Body]

Hereinafter, the method of producing a heat-resistant silane crosslinked resin formed body of the present invention will be described.

In the method of producing a heat-resistant silane crosslinked resin formed body of the present invention, the silane crosslinkable resin composition of the present invention is produced by performing the following steps (a) to (c).

The method of producing a heat-resistant silane crosslinked resin formed body and the method of producing a silane crosslinkable resin composition of the present invention may be collectively referred to as “production method of the present invention”.

The method of producing a heat-resistant silane crosslinked resin formed body of the present invention includes the following steps (a) to (e), and the method of producing a silane crosslinkable resin composition of the present invention includes the following steps (a) to (c). These make it possible to produce a heat-resistant silane crosslinked resin formed body exhibiting the characteristics described above while suppressing foaming during melt-mixing and forming.

Step (a): a step of preparing a silane masterbatch by melt-mixing a part of the base resin, the boehmite, the silane coupling agent having a grafting reaction site capable of being graft-reacted with the base resin, and an organic peroxide at a temperature equal to or higher than a decomposition temperature of the organic peroxide.

Step (b): a step of preparing a catalyst masterbatch by melt-mixing a remainder of the base resin, and the silanol condensation catalyst.

Step (c): a step of obtaining a silane crosslinkable resin composition by dry blending the silane masterbatch prepared in the step (a) and the catalyst masterbatch prepared in the step (b).

Step (d): a step of obtaining a formed body by forming the silane crosslinkable resin composition obtained in the step (c).

Step (e): a step of obtaining a heat-resistant silane crosslinked resin formed body by bringing the formed body obtained in the step (d) and water into contact with each other.

The hindered phenol-based antioxidant and the benzimidazole-based antioxidant may be mixed in either the step (a) or the step (b), but mixing in the step (b) is preferable from the viewpoint of being able to efficiently progress the grafting reaction in the step (a). Both the antioxidants, particularly the hindered phenol-based antioxidant can be mixed in the step (a) within a range not inhibiting the grafting reaction (e.g. 1 part by mass or less with respect to 100 parts by mass of the base resin).

In the production method of the present invention, the mixing amount of each component used as the base resin is the same as the content rate described above as the composition of the base resin. In addition, the mixing amount of each of the boehmite, the silane coupling agent, the silanol condensation catalyst, the hindered phenol-based antioxidant, the benzimidazole-based antioxidant, further the inorganic filler other than the boehmite, and the additive is the same as the content of each of these components in the above-described silane crosslinkable resin composition.

The mixing amount of the organic peroxide mixed in the step (a) is 0.01 to 0.5 parts by mass, preferably 0.1 to 0.2 parts by mass, with respect to 100 parts by mass of the base resin. Setting the mixing amount of the organic peroxide within the above range makes it possible to obtain a heat-resistant silane crosslinked resin formed body having a smooth surface without generating aggregates (lumps) caused by a crosslinked gel or the like.

In the production method of the present invention, a part of the base resin to be mixed in the step (a) is not particularly limited, and may be a specific resin component or two or more kinds of resin components, and is appropriately selected. Examples thereof include an ethylene copolymer, a polyolefin resin, an ethylene rubber, a styrene-based elastomer, and an organic oil. The remainder of the base resin (carrier resin) to be mixed in the step (b) is determined depending on a part of the base resin to be mixed in the step (a). It is preferable to contain an ethylene copolymer, and it is more preferable to further contain a styrene-based elastomer and an organic oil. The ratio of the base resin to be mixed in the step (a) is preferably 60 to 95 mass %, more preferably 70 to 85 mass %, with respect to 100 mass % of the base resin to be mixed in the steps (a) and (b).

<Step (a)>

The step (a) is a step of preparing a silane masterbatch (a silane MB) containing a silane crosslinkable resin in which a silane coupling agent is graft-bonded to a base resin (particularly an ethylene copolymer), by subjecting the base resin and the silane coupling agent to a grafting reaction in the coexistence of boehmite.

In this step, the base resin is heated and mixed with the boehmite and the silane coupling agent in the presence of the organic peroxide at a temperature equal to or higher than the decomposition temperature of the organic peroxide. As a result, the silane MB is obtained as a melt-mixture.

In the step (a), the mixing temperature at which the above-described components are melt-mixed (also referred to as “melt-kneaded”) is equal to or higher than the decomposition temperature of the organic peroxide, preferably a temperature of the decomposition temperature of the organic peroxide plus (25 to 110°) C, more preferably 150 to 230° C. Mixing conditions, such as, a mixing time can be appropriately set. For example, the mixing time can be 1 to 40 minutes. Melt-mixing is performed at a temperature equal to or higher than the decomposition temperature of the organic peroxide, and thus the organic peroxide is thermally decomposed to generate radicals. Consequently, the grafting reaction progresses.

As a mixing method, a method ordinarily applied for rubber, plastic or the like may be used. As a mixing device, for example, a single screw extruder, a twin screw extruder, a roll, a Banbury mixer, various kneaders, or the like is used, and a sealed mixer such as a Banbury mixer or various kneaders is preferable.

In the present invention, the mixing order is not specified, and the above-described components may be mixed in any order. For example, the components described above can be melt-mixed at the same time.

In the production method of the present invention, the mixing of the step (a) is preferably performed in the following mixing order through the following steps (a-1) and (a-2).
Step (a-1): a step of preparing a mixture by mixing boehmite and the silane coupling agent
Step (a-2): a step of melt-mixing the mixture obtained in the step (a-1) and a part of the base resin in the presence of an organic peroxide at a temperature equal to or higher than a decomposition temperature of the organic peroxide

The boehmite and the silane coupling agent are premixed in the step (a-1), the silane coupling agent bonded or adsorbed to the boehmite by weak bonding and the silane coupling agent bonded or adsorbed to the boehmite by strong bonding can be formed in a well-balanced manner. As a result, in the melt-mixing of the step (a-2), the silane coupling agent is less likely to volatilize, and a condensation reaction between unadsorbed silane coupling agents can be prevented. Consequently, a formed body excellent in appearance can be produced. Here, the weak bonding to the boehmite includes mutual action caused by hydrogen bonding, mutual action between ions, partial charges, or dipoles, action caused by adsorption, and the like. Further, the strong bonding to the boehmite includes chemical bonding to a site capable of being chemically bonded to the surface of the boehmite, and the like.

The mixing method and mixing conditions in the step (a-1) are not particularly limited, and examples thereof include a method and conditions in which mixing is performed by a dry method or a wet method, ordinarily at a temperature lower than the decomposition temperature of the organic peroxide, preferably 10 to 60° C., more preferably near room temperature (20 to 25° C.) for about several minutes to several hours using a known mixer. Particularly, dry mixing (dry blending) is preferably performed at a temperature lower than the decomposition temperature of the organic peroxide. Other conditions for dry mixing are appropriately determined.

In the step (a-1), the base resin can be mixed as long as the temperature lower than the decomposition temperature is maintained.

The organic peroxide is only required to exist when melt-mixing in the step (a-2) is performed, and may be mixed in the step (a-2), or preferably mixed in the step (a-1).

Then, the mixture obtained in the step (a-1) and a part of the base resin are melt-mixed in the presence of the organic peroxide at a temperature equal to or higher than the decomposition temperature of the organic peroxide to prepare a silane MB (step (a-2)). In this manner, a silane masterbatch including the silane crosslinkable resin is prepared. In the melt-mixing in this step, it is possible to prevent an excessive crosslinking reaction between the base resins while suppressing the volatilization and self-condensation of the silane coupling agent described above. Further, it is possible to perform melt-mixing while effectively prevent the melt-mixture from foaming. As a result, it is possible to produce a heat-resistant silane crosslinked resin formed body having a smooth surface and excellent appearance characteristics without lumps and foaming.

The melt-mixing method and conditions in the step (a-2) are not particularly limited, and the melt-mixing method and conditions in the step (a) can be applied.

In the step (a-2), at least the following is considered as an aspect in which the silane coupling agent is graft-reacted with the base resin. That is, there is an aspect in which the silane coupling agent bonded or adsorbed to the boehmite by weak bonding is detached from the boehmite, and is graft-reacted with the base resin. From this aspect, the crosslinked structure formed in the step (e) as described later does not incorporate the boehmite, and ordinarily becomes a crosslinked structure through a silanol condensate between silane coupling agents. Further, there is an aspect in which the silane coupling agent bonded or adsorbed to the boehmite by strong bonding is graft-reacted with a resin, in a state of maintaining the bond or adsorption to the boehmite. From this aspect, the crosslinked structure formed in the step (e) described later incorporates the boehmite, and becomes a crosslinked structure through a silane coupling agent bonded to the boehmite as a starting point.

In the step (a), an antioxidant, an inorganic filler other than boehmite, an additive, and the like can also be mixed. However, in the step (a), it is preferable that the silanol condensation catalyst is not substantially mixed. This makes it possible to suppress the occurrence of the silanol condensation reaction of the silane coupling agent. Here, the phrase “not substantially mixed” does not meant to exclude the situation in which the silanol condensation catalyst unavoidably exists, and means that the silanol condensation catalyst may exist in a range that can suppress the silanol condensation reaction, for example, in a range of 0.01 parts by mass or less with respect to 100 parts by mass of the base resin.

The silane MB prepared in the step (a) contains a reaction mixture of the base resin, the boehmite, and the silane coupling agent, and contains a silane crosslinkable resin (silane graft polymer) in which the silane coupling agent is graft-bonded to the base resin to such an extent that it can be formed by the step (b) as described later. The silane coupling agent graft-bonded to the base resin includes a silane coupling agent bonded or adsorbed to boehmite or an inorganic filler other than the boehmite present as appropriate, at a silanol condensable reaction site.

The silane MB is preferably in the form of a pellet or a powder.

<Step (b)>

In the production method of the present invention, a catalyst masterbatch (catalyst MB) is prepared by melt-mixing the remainder of the base resin and the silanol condensation catalyst.

The melt-mixing method and conditions in the step (b) are not particularly limited, and the melt-mixing method and conditions in the step (a) can be applied. For example, the melt-mixing temperature may be equal to or higher than the melting temperature of the base resin, and is preferably 120 to 200° C., more preferably 140 to 180° C. The mixing time can be 1 to 25 minutes, and is preferably 3 to 20 minutes.

The catalyst MB is preferably in the form of a pellet or a powder.

<Step (c)>

In the production method of the present invention, the silane masterbatch and the catalyst masterbatch are then dry-blended to prepare a silane crosslinkable resin composition.

The mixing method and conditions are not particularly limited, and it is preferable to employ a method and conditions of dry blending under non-high temperature conditions from the viewpoint of suppressing the occurrence or progress of the silanol condensation reaction. Examples thereof include the method and conditions of dry mixing in the step (a-1).

In this manner, the silane crosslinkable resin composition of the present invention is produced.

This silane crosslinkable resin composition contains a silane crosslinkable resin, boehmite, a silanol condensation catalyst, and the like. In the silane crosslinkable resin, the silanol condensable reaction site of the silane coupling agent may be bonded or adsorbed to the boehmite, but is not silanol condensed. Therefore, the silane crosslinkable resin contains the silane crosslinkable resin in which the silane coupling agent bonded or adsorbed to the boehmite is graft-bonded to the base resin, and the silane crosslinkable resin in which the silane coupling agent not bonded or adsorbed to the boehmite is graft-bonded to the base resin.

<Step (d)>

In the production method of the present invention, the silane crosslinkable resin composition is then formed to obtain a formed body. In the step (d), the formation is ordinarily performed by melt-mixing the silane crosslinkable resin composition as a dry-blended product.

The forming method is not particularly limited, and is appropriately selected according to the form of the target product. Examples of the forming method include extrusion forming using an extruder, extrusion forming using an injection forming machine, and forming using any other forming machine. In the case of producing a wiring material, the extrusion forming method is preferable from the viewpoint of productivity, and further from the viewpoint of being able to perform coextrusion with a conductor, and the like.

The forming conditions (melt-mixing conditions) are not particularly limited as long as uniform mixing is possible. For example, the melt-mixing method and conditions in the step (a) can be applied. For example, the melt-mixing temperature in this step is set to a temperature equal to or higher than the temperature at which the base resin melts, and is preferably 80 to 250° C., more preferably 100 to 240° C., and still more preferably 120 to 200° C. In this melt-mixing, formability of the melt-mixture of the silane crosslinkable resin composition is kept, and the melt-mixing method and conditions are set. The silane crosslinkable resin in the melt-mixture is an uncrosslinked body in which the silane coupling agent is not subjected to silanol condensation. Practically, when the melt-mixing is performed in the step (d), crosslinking of part (partial crosslinking) cannot be avoided, but formability is kept on the melt-mixture to be obtained. For example, in order to avoid the occurrence or progress of the silanol condensation reaction, it is preferable that the melt-mixed silane crosslinkable resin composition is not kept in a high temperature state for a long period of time.

The step (d) can be executed simultaneously with the step (c) or both steps can be continuously executed. It is possible to employ, for example, a series of steps of dry blending the silane MB and the catalyst MB in a coating device (extruder), then melt-mixing the resultant mixture, and then forming (coextrusion forming) on an outer periphery of a conductor or the like.

<Step (e)>

In the production method of the present invention, the formed body obtained in the step (d) and water are then brought into contact with each other to produce a heat-resistant silane crosslinked resin formed body. Since the formed body obtained in the step (d) is an uncrosslinked body, in this step, a silanol condensation reaction of a silanol condensable reaction site of the silane coupling agent graft-bonded to the base resin is caused to occur and progress (accelerate), and finally a crosslinked formed body is formed.

The contact between the uncrosslinked formed body and water can be performed by an ordinary method. The silanol condensation reaction progresses only by being left standing at normal temperature, for example, in a temperature environment of about 20 to 25° C. It is preferable that the silanol condensation reaction (crosslinking reaction) is accelerated by actively bringing the uncrosslinked formed body into contact with water. The contact method is, for example, a method (condition) ordinarily applied to the silane crosslinking method. For example, various contact methods such as immersion in warm water, placement in a moist-heat tank, and exposure to water vapor at high temperatures can be applied.

In this manner, the heat-resistant silane crosslinked resin formed body of the present invention is produced.

The heat-resistant silane crosslinked resin formed body contains a crosslinked resin in which the base resin is condensed via a siloxane bond. The heat-resistant silane crosslinked resin formed body contains boehmite, and the boehmite may be bonded to a silane coupling agent of the crosslinked resin. Therefore, it is considered that the crosslinked resin contains a crosslinked resin in which a plurality of base resins is bonded or adsorbed to boehmite by a silane coupling agent and bonded (crosslinked) through the boehmite and the silane coupling agent, and a crosslinked resin in which the hydrolyzable groups of the silane coupling agent graft-bonded to the base resin are hydrolyzed and silanol condensation reacted with each other to be crosslinked through the silane coupling agent (siloxane bond) (without through the boehmite).

Regarding the method of producing a heat-resistant silane crosslinked resin formed body of the present invention, in the melt-mixing step, the kneaded product contains the above content of boehmite and further contains an antioxidant, and thus the viscosity of the kneaded product is reduced (kneadability (fluidity) is enhanced), and the series of steps described above can be executed while suppressing the volatilization and self-condensation reaction of the silane coupling agent, and further suppressing foaming during melt-mixing. Accordingly, in the method of producing a heat-resistant silane crosslinked resin formed body of the present invention, it is possible to produce a heat-resistant silane crosslinked resin formed body that exhibits high heat resistance of, for example, 150° C. or higher and has a smooth surface and excellent appearance characteristics without lumps and foaming even by a simple silane crosslinking method that has a problem in appearance characteristics using a lightweight and inexpensive polyolefin resin.

The heat-resistant silane crosslinked resin formed body of the present invention exhibits high heat resistance with a predicted 40000 hour life temperature of 125° C. or higher as defined by JASO, and further exhibits higher heat resistance with a predicted 10000 hour life temperature of 150° C. or higher as recently required.

### [Wiring Material]

The wiring material of the present invention is a wiring material having a coating layer on an outer periphery of a conductor, in which the coating layer is formed of the heat-resistant silane crosslinked resin formed body of the present invention obtained by forming the silane crosslinkable resin composition of the present invention into a layer and crosslinking the layer. Accordingly, the wiring material of the present invention exhibits high heat resistance (e.g. 150° C. or higher), and has excellent appearance characteristics. Further, the wiring material is lightweight and inexpensive. The wiring material of the present invention is suitable as a heat-resistant electric wire (heat-resistant insulated wire) or cable.

The wiring material of the present invention is the same as an ordinary wiring material used in various electrical- or electronic-equipment fields and industrial fields, except that at least one coating layer is formed of the heat-resistant silane crosslinked resin formed body of the present invention. The coating layer formed of the heat-resistant silane crosslinked resin formed body of the present invention is provided directly or through another layer on the outer periphery of the conductor, and the presence or absence of the other layer, material, and the like are appropriately determined according to the type, use, required characteristics, and the like of the wiring material. As the conductor, an ordinary conductor can be used, and examples thereof include a single wire or a twisted wire (one obtained by vertically attaching or twisting tensile strength fibers) of copper or aluminum. Moreover, in addition to a bare wire, a tin-plated conductor or a conductor having an enamel-coating insulation layer can be used. The thickness of the coating layer formed of the heat-resistant silane crosslinked resin formed body of the present invention is not particularly limited, and is ordinarily about 0.15 to 5 mm.

The wiring material of the present invention can be produced by disposing the silane crosslinkable resin composition of the present invention in a layer shape on the outer periphery of a conductor and then subjecting the silane crosslinkable resin composition to a crosslinking reaction (silanol condensation reaction). For example, in the method of producing a heat-resistant silane crosslinked resin formed body of the present invention described above, the wiring material of the present invention can be produced by setting the forming step (d) to the step of coextrusion forming the silane crosslinkable resin composition on the outer periphery of the conductor using a coating device (extruder). Specific coextrusion forming is as described above.

### EXAMPLES

Hereinafter, the present invention will be described in more detail based on Examples, but the present invention is not limited to the following Examples.

The compounds used in Examples and Comparative Examples are shown below.

### <Base Resin>

(1) EVOLUE SP0540: trade name, linear metallocene polyethylene (LLDPE), manufactured by Prime Polymer Co., Ltd.
(2) VF120T: trade name, EVA, manufactured by Ube-Maruzen Polyethylene Co., Ltd., VA content: 20 mass %
(3) EVAFLEX EV170: trade name, EVA, manufactured by DOW-MITSUI POLYCHEMICALS CO., LTD., VA content: 33 mass %
(4) REXPEARL A1150: trade name, EEA, manufactured by Mitsubishi Chemical Corporation, EA content: 15 mass %
(5) EPT3092PM: trade name, EPDM, manufactured by Mitsui Chemicals, Inc.
(6) PB222A: trade name, random PP, manufactured by SunAllomer Ltd.
(7) TUFTEC N504: trade name, SEBS, manufactured by Asahi Kasei Corporation
(8) Diana Process Oil PW-90: trade name, organic oil (paraffin oil), manufactured by Idemitsu Kosan Co., Ltd.

### <Boehmite>

Boehmite FKB104: trade name, boehmite, manufactured by Konoshima Chemical Co., Ltd., the remaining amount of aluminum hydroxide measured by the following content measurement method: 10 mass %

<Inorganic Filler Other than Boehmite>
(1) BF013: trade name, aluminum hydroxide, manufactured by Nippon Light Metal Co., Ltd.
(2) KISUMA 5: trade name, magnesium hydroxide, manufactured by Kyowa Chemical Industry Co., Ltd.
(3) Boehmite mixed aluminum hydroxide (synthesized using BF013 as a raw material by the following wet hydrothermal treatment)

### (Synthesis of Boehmite Mixed Aluminum Hydroxide)

4 kg of aluminum hydroxide powder (BF013) was weighed and put into a 30 L volume polyethylene container, and 16 L of pure water was added thereto and stirred to prepare a slurry of aluminum hydroxide. This slurry was poured into an autoclave having a wetted part made of Hastelloy (registered trademark) C-276, and subjected to hydrothermal treatment at 170° C. for about 6 hours under stirring to synthesize boehmite mixed aluminum hydroxide. The boehmite slurry after the hydrothermal treatment was cooled to room temperature and dried, and then the resultant product was pulverized to obtain boehmite mixed aluminum hydroxide powder. The content of aluminum hydroxide in the resulting boehmite mixed aluminum hydroxide was 47 mass %.

### (Method of Measuring Content of Aluminum Hydroxide)

The content (remaining amount) of aluminum hydroxide in the boehmite or the boehmite mixed aluminum hydroxide was quantified by the following method.

First, the loss on ignition of a target sample was measured in accordance with JIS R 9301-3-2. However, the loss on ignition at 105 to 900° C. was measured. The “loss on ignition” is obtained by measuring the amount of decrease in mass of the target sample when heated. The “loss on ignition at 105 to 900° C.” means a “mass obtained by subtracting the mass reduced when heated at 105° C. from the mass reduced when heated at 900° C.”.

Thereafter, the content of aluminum hydroxide was determined using the following formula.

$$R = ( I 1 - I 2 ) / ( I 3 - I 2 ) \times 100$$

The denotation of reference numerals in the formula above is as follows:
R: content rate of aluminum hydroxide (%);
I1: loss on ignition (%) of target sample obtained by method above;
I2: theoretical value (%) of loss on ignition of boehmite=15.0; and
I3: theoretical value (%) of loss on ignition of aluminum hydroxide=34.6.

### <Antioxidant>

(1) IRGANOX 1076: trade name, hindered phenol-based antioxidant, manufactured by BASF
(2) IRGANOX 1010: trade name, hindered phenol-based antioxidant, manufactured by BASF
(3) ADK STAB CDA-10: trade name, a hindered phenol-based antioxidant, manufactured by ADEKA CORPORATION
(4) NOCRAC MBZ: trade name, benzimidazole-based antioxidant, manufactured by OUCHI SHINKO CHEMICAL INDUSTRIAL CO., LTD.

### <Silane Coupling Agent>

KBM-1003: trade name, vinyltrimethoxysilane, manufactured by Shin-Etsu Chemical Co., Ltd.

### <Silanol Condensation Catalyst>

ADK STAB OT-1: trade name, dioctyltin dilaurate, manufactured by ADEKA CORPORATION

### <Organic Peroxide>

“PERHEXA 25B” (trade name, manufactured by NOF CORPORATION., 2,5-dimethyl-2,5-di(t-butylperoxy)hexane, decomposition temperature 154° C.)

### <Lubricant>

X-21-3043: trade name, silicone gum, manufactured by Shin-Etsu Chemical Co., Ltd.

### Examples 1 to 13 and Comparative Examples 1 to 12

Each of Examples 1 to 13 and Comparative Examples 1 to 12 were executed using the components shown in Tables 1 and 2.

In Tables 1 to 2, the numerical values for the composition amount (content) of the respective examples and comparative examples are in terms of part by mass, unless otherwise specified. In addition, in each component column, the blank means that a composition amount of a corresponding component is 0 part by mass.

In each of the examples and comparative examples, a part of the base resin (specifically, the “carrier resin” shown in the “Catalyst MB” column in Tables 1 and 2) was used in the mass ratio shown in the same column as the carrier resin of the catalyst MB.

First, boehmite or an inorganic filler other than boehmite, a silane coupling agent, and an organic peroxide, in mass ratios shown in the “Silane MB” column in Tables 1 and 2, were placed in a rotary blade mixer (Mazelar PM: trade name, manufactured by Mazelar CO., LTD.), and the resultant mixture was stirred (premixed) at a rotation speed of 10 rpm for 1 minute at room temperature (25° C.) (step (a-1)). Thus, a powder mixture was obtained.

Next, the powder mixture, and a base resin, an antioxidant, a lubricant shown in the “Silane MB” column in Tables 1 and 2, in mass ratios shown in the same column, were placed in a kneader (volume: 75 L) heated to 150° C. in advance, the resultant mixture was mixed at a rotation speed of 40 rpm for 5 minutes, and further subjected to finish kneading (melt-mixing) at a rotation speed of 30 rpm for 3 minutes. After confirming that the temperature of the resin (temperature of the mixture) reached 180 to 200° C., i.e. temperatures equal to or higher than a decomposition temperature of the organic peroxide, and the melt-mixture was pelletized using a feeder-loader and a pelletizer to obtain a silane MB (step (a) in conjunction with steps (a-2) and (a-1)).

Meanwhile, a carrier resin, an antioxidant, and a silanol condensation catalyst, in mass ratios shown in the “Catalyst MB” column in Tables 1 and 2, were sequentially placed in a kneader (volume: 75 L) heated to 130° C. in advance, the resultant mixture was mixed at a rotation speed of 30 rpm for 5 minutes, and then subjected to finish kneading (melt-mixing) at a rotation speed of 25 rpm for 3 minutes. After confirming that the temperature of the resin (temperature of the mixture) reached about 160° C. and the carrier resin was sufficiently melted, the resultant mixture was pelletized using a feeder-loader and a pelletizer to obtain a catalyst MB (step (b)).

Then, immediately before extrusion forming, pellets of the silane MB and pellets of the catalyst MB were dry-blended at room temperature (25° C.) for 2 minutes using a tumbler mixer, to obtain a silane crosslinkable resin composition (step (c)). At this time, the mixing ratios of the silane MB and the catalyst MB was set to the mass ratios shown in the “Silane MB” column and the “Catalyst MB” column in Tables 1 and 2.

Next, the resulting silane crosslinkable resin composition was introduced into a 40 mm (screw diameter)-extruder (with a ratio of a screw effective length L to a diameter D: L/D=24, temperature of screw of compression unit: 160° C., temperature of head: 180° C.), and the outer periphery of the 1/0.8A conductor was coated to have a thickness of 1 mm to obtain an uncrosslinked electric wire with an outer diameter of 2.8 mm (step (d)).

The resulting uncrosslinked electric wire was left to stand in an atmosphere at a temperature of 60° C. and a humidity of 95% RH for 24 hours to bring the silane crosslinkable resin composition and water into contact with each other (step (e)).

In this manner, insulated crosslinked electric wires having the coating layer formed of the heat-resistant silane crosslinked resin formed body were produced.

The produced insulated crosslinked electric wires were evaluated as follows, and the results are shown in Tables 1 and 2.

### <Appearance Characteristics>

Each of the insulated crosslinked electric wires was subjected to an appearance characteristic test.

The evaluation items includes the surface smoothness, the presence or absence of lumps, and the presence or absence of foaming inside the coating layer.

### (Surface Smoothness)

Regarding a 5 m-electric wire sample cut out from each of the insulated crosslinked electric wires, the surface smoothness was evaluated by visually observing and touching the smooth state of the entire surface of the coating layer (the presence or absence of recesses and protrusions). As a result, a case where the surface of the coating layer had a smooth texture was rated as “A”, a case where the surface of the coating layer had a slight rough texture but was visually good was rated as “B”, and a case where the roughness of the coating layer was visually confirmed was rated as “C”. Samples rated as “A” and “B” were judged as an acceptable product level.

### (Presence or Absence of Lumps)

Regarding a 5 m-electric wire sample cut out from each of the insulated crosslinked electric wires, the presence or absence of lumps was evaluated by visually observing and touching the entire surface of the coating layer. As a result, a case where lumps (protruding aggregates) could not be confirmed by visually observing and touching the entire surface was rated as “A”, a case where lumps could not be visually confirmed but could be confirmed by touching the surface was rated as “B”, and a case where lumps could be visually confirmed was rated as “C”. Samples rated as “A” and “B” were judged as an acceptable product level.

### (Presence or Absence of Foaming)

A coating layer of a 1 m-insulated crosslinked electric wire cut out from each of the insulated crosslinked electric wires was sliced into two (semi-cylindrical shape) in a plane along the axis including the axis of the insulated crosslinked electric wire. The entire cross section of one of the cut coating layers was observed with a binocular stereo microscope at a magnification of 10 times, and the presence or absence of foaming (cavity portion) in the cross section was evaluated. In this evaluation, in a case where at least one cavity portion having the longest portion of 0.05 mm or more as measured by the shape measurement could be confirmed (was present) in the entire cross section, or in a case where five or more cavity portions could be confirmed (were present) regardless of the size, it was determined that foaming was present in the cross section. As a result, a case where foaming could not be confirmed in the cross section was rated as “A”, and a case where foaming could be confirmed in the cross section was rated as “C”. A sample rated as “A” was judged as an acceptable product level.

### <Heat Resistance>

The heat resistance of each of the insulated crosslinked electric wires thus produced was evaluated based on predicted 10000 hour life temperature and predicted 40000 hour life temperature. That is, each of the insulated crosslinked electric wires thus produced was heated to a temperature of 170° C., 180° C., or 200° C., and the tensile strength and the elongation at break, after heating, were measured. Regarding the tensile strength and the elongation at break, a coating layer of a tubular piece collected from each of the insulated crosslinked electric wires thus produced was pulled under the conditions at gauge line interval of 20 mm and a tensile rate of 500 mm/min, and then the tensile strength (MPa) and the tensile elongation (%) were measured in accordance with JIS C 3005 ((2014) 4.16 Tensile properties of insulation and sheath).

At each temperature, the heating time at which the tensile strength after heating was 3.92 MPa and the heating time at which the elongation at break was 100% or 50% were determined. Arrhenius plots were created for the tensile strength and the elongation at break from the determined heating time and heating temperature. The predicted 10000 hour life temperature and the predicted 40000 hour life temperature were determined from the plots (by an extrapolation method).

In the present invention, the term “10000 hour life” means that the elongation at break of the insulated crosslinked electric wire becomes 100% after being heated at a specific temperature for 10000 hours. The term “40000 hour life” means that the tensile strength of the insulated crosslinked electric wire becomes 3.92 MPa or the elongation at break becomes 50% after being heated at a specific temperature for 40000 hours.

Since the present invention realizes higher heat resistance than before, a sample having a predicted 10000 hour life temperature of 150° C. or higher was judged as an acceptable product, and a sample having a predicted 10000 hour life temperature of lower than 150° C. was judged as an unacceptable product. The predicted 40000 hour life temperature is a test for evaluating relatively high long-term heat resistance, and was determined for reference in the present invention. Accordingly, pass-fail criteria were not provided.

In Tables 1 and 2, the “predicted 10000 hour life temperature” and the “predicted 40000 hour life temperature” are expressed as “10000 Hr heat resistant temperature” and “40000 Hr heat resistant temperature”, respectively.

### <Evaluation of Crosslinkability (Heating Deformation Test)>

Whether or not the coating layer (heat-resistant silane crosslinked resin formed body) was sufficiently crosslinked was evaluated for each of the produced insulated crosslinked electric wires by a heating deformation test.

This heating deformation test was executed based on JASO D 625-2 (2020) (4.4 Heating deformation test). Specifically, each loaded insulated crosslinked electric wire was placed in a constant temperature bath heated to 150° C. for 4 hours, taken out, and quickly put in cold water within 10 seconds for cooling. Thereafter, the insulated crosslinked electric wire was immersed in salt water for 10 minutes, and a voltage of 1 kV was applied to the wire for 1 minute. A sample in which the coating layer was not broken by the end of voltage application was judged as an acceptable product, and a sample in which the crosslinking was broken was judged as an unacceptable product.

TABLE 1

| | | | | Example | | | |
|---|---|---|---|---|---|---|---|
| | | | | 1 | 2 | 3 | 4 |
| Silanol | Base resin | EVOLUE SP0540 | LLDPE | | | 20 | 20 |
| MB | | VF120T | EVA | 60 | 60 | 20 | |
| | | EVAFLEX EV170 | EVA | | | | 20 |
| | | REXPEARL A1350 | EEA | | | | |
| | | EPT3092PM | EPDM | | | 10 | |
| | | PB 222A | Random PP | | | 10 | 10 |
| | | TUFTEC N504 | SEBS | 5 | 5 | 5 | 10 |
| | | Diana Process Oil PW-90 | Organic oil | 5 | 5 | 5 | 10 |
| | Boehmite | Boehmite FKB104 | Boehmite | 30 | 30 | 30 | 30 |
| | Hindered phenol-based | IRGANOX 1076 | | 0.05 | 0.1 | 0.1 | 0.1 |
| | antioxidant | | | | | | |
| | lubricant | X-21-3043 | Silicone gum | 2 | 2 | 2 | 2 |
| | Silane coupling agent | KBM-1003 | | 3 | 3 | 3 | 3 |
| | Organic peroxide | PERHEXA 256 | | 0.1 | 0.1 | 0.1 | 0.1 |
| Catalyst | Carrier resin | EVOLUE SP0540 | LLDPE | | | | |
| MB | | VF120T | EVA | 20 | 20 | 20 | |
| | | EVAFLEX EV170 | EVA | | | | 20 |
| | | REXPEARL A1350 | EEA | | | | |
| | | TUFTEC N504 | SEBS | 5 | 5 | 5 | 5 |
| | | Diana Process Oil PW-90 | Organic oil | 5 | 5 | 5 | 5 |
| | Hindered phenol-based | IRGANOX 1010 | | 0.2 | 1 | 1 | 1 |
| | antioxidant | ADK STAB CDA-10 | | 0.2 | 0.5 | 0.5 | 0.5 |
| | Benzinidazole-based | NOCRAC MBZ | | 3.5 | 8 | 8 | 8 |
| | antioxidant | | | | | | |
| | Silanol condensation | ADK STAB OT-1 | | 0.05 | 0.05 | 0.05 | 0.05 |
| | catalyst | | | | | | |

| Silane crosslinkable resin | Total content rate of ethylene-based copolymer | | 80 | 80 | 40 | 40 |
|---|---|---|---|---|---|---|
| composition | Substantial content of boehmite | | 27 | 27 | 27 | 27 |
| | Substantial content of aluminum hydroxide | | 3 | 3 | 3 | 3 |
| | Content of hindered phenol-based antioxidant | | 0.45 | 1.6 | 1.6 | 1.6 |
| | Content of benzimidazole-based antioxidant | | 3.5 | 8 | 8 | 8 |
| Evaluation | Appearance characteristics | Surface smoothness | B | B | A | A |
| | | Presence or absence of | B | B | A | B |
| | | lumps | | | | |
| | | Presence or absence of | A | A | A | A |
| | | foaming | | | | |
| | Heat resistance | 10000 Hr heat resistant | 151 | 159 | 155 | 157 |
| | | temperature | | | | |
| | | 40000 Hr heat resistant | 136 | 143 | 138 | 138 |
| | | temperature | | | | |
| | Evaluation of crosslinkability | Heating deformation test | Acceptable | Acceptable | Acceptable | Acceptable |

| | | | | Example | | |
|---|---|---|---|---|---|---|
| | | | | 5 | 6 | 7 |
| Silanol | Base resin | EVOLUE SP0840 | LLDPE | 20 | 30 | 20 |
| MB | | VF120T | EVA | | | 20 |
| | | EVAFLEX EV170 | EVA | | | |
| | | REXPEARL A1350 | EEA | 20 | | |
| | | EPT3092PM | EPDM | | 10 | 10 |
| | | PB 222A | Random PP | 10 | 10 | 10 |
| | | TUFTEC N504 | SEBS | 10 | 5 | 5 |
| | | Diana Process Oil PW-90 | Organic oil | 10 | 5 | 5 |
| | Boehmite | Boehmite FKB104 | Boehmite | 30 | 30 | 10 |
| | Hindered phenol-based | IRGANOX 1076 | | 0.1 | 0.1 | 0.1 |
| | antioxidant | | | | | |
| | lubricant | X-21-3043 | Silicone gum | 2 | 2 | 2 |
| | Silane coupling agent | KBM-1003 | | 3 | 3 | 3 |
| | Organic peroxide | PERHEXA 256 | | 0.1 | 0.1 | 0.1 |
| Catalyst | Carrier resin | EVOLUE SP0540 | LLDPE | | | |
| MB | | VF120T | EVA | | 10 | 20 |
| | | EVAFLEX EV170 | EVA | | | |
| | | REXPEARL A1350 | EEA | 20 | | |
| | | TUFTEC N504 | SEBS | 5 | 10 | 5 |
| | | Diana Process Oil PW-90 | Organic oil | 5 | 10 | 5 |
| | Hindered phenol-based | IRGANOX 1010 | | 1 | 1 | 1 |
| | antioxidant | ADK STAB CDA-10 | | 0.5 | 0.5 | 0.5 |
| | Benzinidazole-based | NOCRAC MBZ | | 8 | 8 | 8 |
| | antioxidant | | | | | |
| | Silanol condensation | ADK STAB OT-1 | | 0.05 | 0.05 | 0.05 |
| | catalyst | | | | | |
| Silane crosslinkable resin | | Total content rate of ethylene-based copolymer | | 40 | 10 | 40 |
| composition | | Substantial content of boehmite | | 27 | 27 | 9 |
| | | Substantial content of aluminum hydroxide | | 3 | 3 | 1 |
| | | Content of hindered phenol-based antioxidant | | 1.6 | 1.6 | 1.6 |
| | | Content of benzimidazole-based antioxidant | | 8 | 8 | 8 |
| Evaluation | | Appearance characteristics | Surface smoothness | A | A | B |
| | | | Presence or absence of | A | A | A |
| | | | lumps | | | |
| | | | Presence or absence of | A | A | A |
| | | | foaming | | | |
| | | Heat resistance | 10000 Hr heat resistant | 154 | 152 | 151 |
| | | | temperature | | | |
| | | | 40000 Hr heat resistant | 137 | 136 | 135 |
| | | | temperature | | | |
| | | Evaluation of crosslinkability | Heating deformation test | Acceptable | Acceptable | Acceptable |
| | | | | Example | | |
| | | | | 8 | 9 | 10 |
| Silanol | Base resin | EVOLUE SP0840 | LLDPE | 20 | 20 | 20 |
| MB | | VF120T | EVA | 20 | 20 | 20 |
| | | EVAFLEX EV170 | EVA | | | |
| | | REXPEARL A1350 | EEA | | | |
| | | EPT3092PM | EPDM | 10 | 10 | 10 |
| | | PB 222A | Random PP | 10 | 10 | 10 |
| | | TUFTEC N504 | SEBS | 5 | 5 | 5 |
| | | Diana Process Oil PW-90 | Organic oil | 5 | 5 | 5 |
| | Boehmite | Boehmite FKB104 | Boehmite | 80 | 30 | 30 |
| | Hindered phenol-based | IRGANOX 1076 | | 0.1 | 0.1 | 0.1 |
| | antioxidant | | | | | |
| | lubricant | X-21-3043 | Silicone gum | 2 | 2 | 2 |
| | Silane coupling agent | KBM-1003 | | 3 | 1 | 15 |
| | Organic peroxide | PERHEXA 256 | | 0.1 | 0.01 | 0.5 |
| Catalyst | Carrier resin | EVOLUE SP0540 | LLDPE | | | |
| MB | | VF120T | EVA | 20 | 20 | 20 |
| | | EVAFLEX EV170 | EVA | | | |
| | | REXPEARL A1350 | EEA | | | |
| | | TUFTEC N504 | SEBS | 5 | 5 | 5 |
| | | Diana Process Oil PW-90 | Organic oil | 5 | 5 | 5 |
| | Hindered phenol-based | IRGANOX 1010 | | 1 | 1 | 1 |
| | antioxidant | ADK STAB CDA-10 | | 0.5 | 0.5 | 0.5 |
| | Benzinidazole-based | NOCRAC MBZ | | 8 | 8 | 8 |
| | antioxidant | | | | | |
| | Silanol condensation | ADK STAB OT-1 | | 0.05 | 0.05 | 0.05 |
| | catalyst | | | | | |
| Silane crosslinkable resin | | Total content rate of ethylene-based copolymer | | 40 | 40 | 40 |
| composition | | Substantial content of boehmite | | 72 | 27 | 27 |
| | | Substantial content of aluminum hydroxide | | 8 | 3 | 3 |
| | | Content of hindered phenol-based antioxidant | | 1.6 | 1.6 | 1.6 |
| | | Content of benzimidazole-based antioxidant | | 8 | 8 | 8 |
| Evaluation | | Appearance characteristics | Surface smoothness | A | A | B |
| | | | Presence or absence of | A | A | B |
| | | | lumps | | | |
| | | | Presence or absence of | A | A | A |
| | | | foaming | | | |
| | | Heat resistance | 10000 Hr heat resistant | 150 | 152 | 151 |
| | | | temperature | | | |
| | | | 40000 Hr heat resistant | 135 | 136 | 135 |
| | | | temperature | | | |
| | | Evaluation of crosslinkability | Heating deformation test | Acceptable | Acceptable | Acceptable |
| | | | | Example | | |
| | | | | 11 | 12 | 13 |
| Silanol | Base resin | EVOLUE SP0840 | LLDPE | 20 | 20 | 20 |
| MB | | VF120T | EVA | 20 | 20 | 20 |
| | | EVAFLEX EV170 | EVA | | | |
| | | REXPEARL A1350 | EEA | | | |
| | | EPT3092PM | EPDM | 10 | 10 | 10 |
| | | PB 222A | Random PP | 10 | 10 | 10 |
| | | TUFTEC N504 | SEBS | 5 | 5 | 5 |
| | | Diana Process Oil PW-90 | Organic oil | 5 | 5 | 5 |
| | Boehmite | Boehmite FKB104 | Boehmite | 30 | 30 | 30 |
| | Hindered phenol-based | IRGANOX 1076 | | 0.1 | 0.1 | 0.1 |
| | antioxidant | | | | | |
| | lubricant | X-21-3043 | Silicone gum | 2 | 2 | 2 |
| | Silane coupling agent | KBM-1003 | | 3 | 3 | 3 |
| | Organic peroxide | PERHEXA 256 | | 0.1 | 0.1 | 0.1 |
| Catalyst | Carrier resin | EVOLUE SP0540 | LLDPE | | | |
| MB | | VF120T | EVA | 20 | 20 | 20 |
| | | EVAFLEX EV170 | EVA | | | |
| | | REXPEARL A1350 | EEA | | | |
| | | TUFTEC N504 | SEBS | 5 | 5 | 5 |
| | | Diana Process Oil PW-90 | Organic oil | 5 | 5 | 5 |
| | Hindered phenol-based | IRGANOX 1010 | | 3 | 1 | 1 |
| | antioxidant | ADK STAB CDA-10 | | 1.5 | 0.5 | 0.5 |
| | Benzinidazole-based | NOCRAC MBZ | | 12 | 8 | 8 |
| | antioxidant | | | | | |
| | Silanol condensation | ADK STAB OT-1 | | 0.05 | 0.01 | 0.5 |
| | catalyst | | | | | |

| Silane crosslinkable resin | Total content rate of ethylene-based copolymer | | 40 | 40 | 40 |
|---|---|---|---|---|---|
| composition | Substantial content of boehmite | | 27 | 27 | 27 |
| | Substantial content of aluminum hydroxide | | 3 | 3 | 3 |
| | Content of hindered phenol-based antioxidant | | 4.6 | 1.6 | 1.6 |
| | Content of benzimidazole-based antioxidant | | 12 | 8 | 8 |
| Evaluation | Appearance characteristics | Surface smoothness | B | A | B |
| | | Presence or absence of | A | A | B |
| | | lumps | | | |
| | | Presence or absence of | A | A | A |
| | | foaming | | | |
| | Heat resistance | 10000 Hr heat resistant | 163 | 153 | 150 |
| | | temperature | | | |
| | | 40000 Hr heat resistant | 145 | 137 | 135 |
| | | temperature | | | |
| | Evaluation of crosslinkability | Heating deformation test | Acceptable | Acceptable | Acceptable |

TABLE 2

| | | | | Comparative example | | | |
|---|---|---|---|---|---|---|---|
| | | | | 1 | 2 | 3 | 4 |
| Silanol | Base resin | EVOLUE SP0540 | LLDPE | 30 | 20 | 20 | 20 |
| MB | | VF120T | EVA | | 20 | 20 | 20 |
| | | EPT3092PM | EPDM | 10 | 10 | 10 | 10 |
| | | PB 222A | Random PP | 10 | 10 | 10 | 10 |
| | | TUFTEC N504 | SEBS | 10 | 5 | 5 | 5 |
| | | Diana Process Oil PW-90 | Organic oil | 10 | 5 | 5 | 5 |
| | Boehmite | Boehmite FKB104 | Boehmite | 30 | 5 | 100 | |
| | Inorganic filler other | BF 013 | Aluminum hydroxide | | | | 30 |
| | than boehmite | KISUMA 5 | Magnesium hydroxide | | | | |
| | | Boehmite mixed aluminum hydroxide | | | | | |
| | Hindered phenol-based | IRGANOX 1076 | | 0.1 | 0.1 | 0.1 | 0.1 |
| | antioxidant | | | | | | |
| | lubricant | X-21-3043 | Silicone gum | 2 | 2 | 2 | 2 |
| | Silane coupling agent | KBM-1003 | | 3 | 3 | 3 | 3 |
| | Organic peroxide | PERHEXA 25B | | 0.1 | 0.1 | 0.1 | 0.1 |
| Catalyst | Carrier resin | EVOLUE SP0540 | LLDPE | 20 | | | |
| MB | | VF120T | EVA | | 20 | 20 | 20 |
| | | TUFTEC N504 | SEBS | 5 | 5 | 5 | 5 |
| | | Diana Process Oil PW-90 | Organic oil | 5 | 5 | 5 | 5 |
| | Hindered phenol-based | IRGANOX 1010 | | 1 | 1 | 1 | 1 |
| | antioxidant | ADK STAB CBA-10 | | 0.5 | 0.5 | 0.5 | 0.5 |
| | Benzimidazole-based | NOCRAC MBZ | | 8 | 8 | 8 | 8 |
| | antioxidant | | | | | | |
| | Silanol condensation | ADK STAB OT-1 | | 0.05 | 0.05 | 0.05 | 0.05 |
| | catalyst | | | | | | |

| Silane crosslinkable resin | Total content rate of ethylene-based copolymer | | 0 | 40 | 40 | 40 |
|---|---|---|---|---|---|---|
| composition | Substantial content of boehmite | | 27 | 4.5 | 90 | 0 |
| | Substantial content of aluminum hydroxide | | 3 | 0.5 | 10 | 30 |
| | Content of hindered phenol-based antioxidant | | 1.6 | 1.6 | 1.6 | 1.6 |
| | Content of benzimidazole-based antioxidant | | 8 | 8 | 8 | 8 |
| Evaluation | Appearance characteristics | Surface smoothness | A | C | A | A |
| | | Presence or absence of | A | A | A | A |
| | | lumps | | | | |
| | | Presence or absence of | A | A | A | C |
| | | foaming | | | | |
| | Heat resistance | 10000 Hr heat resistant | 144 | 148 | 146 | 154 |
| | | temperature | | | | |
| | | 40000 Hr heat resistant | 130 | 133 | 131 | 138 |
| | | temperature | | | | |
| | Evaluation of crosslinkability | Heating deformation test | Acceptable | Unac- | Acceptable | Acceptable |
| | | | | ceptable | | |

| | | | | Comparative example | | | |
|---|---|---|---|---|---|---|---|
| | | | | 5 | 6 | 7 | 8 |
| Silanol | Base resin | EVOLUE SP0540 | LLDPE | 20 | 20 | 20 | 20 |
| MB | | VF120T | EVA | 20 | 20 | 20 | 20 |
| | | EPT3092PM | EPDM | 10 | 10 | 10 | 10 |
| | | PB 222A | Random PP | 10 | 10 | 10 | 10 |
| | | TUFTEC N504 | SEBS | 5 | 5 | 5 | 5 |
| | | Diana Process Oil PW-90 | Organic oil | 5 | 5 | 5 | 5 |
| | Boehmite | Boehmite FKB104 | Boehmite | | | 30 | 30 |
| | Inorganic filler other | BF 013 | Aluminum hydroxide | | | | |
| | than boehmite | KISUMA 5 | Magnesium hydroxide | 30 | | | |
| | | Boehmite mixed aluminum hydroxide | | | 30 | | |
| | Hindered phenol-based | IRGANOX 1076 | | 0.1 | 0.1 | 0.1 | |
| | antioxidant | | | | | | |
| | lubricant | X-21-3043 | Silicone gum | 2 | 2 | 2 | 2 |
| | Silane coupling agent | KBM-1003 | | 3 | 3 | 3 | 3 |
| | Organic peroxide | PERHEXA 25B | | 0.1 | 0.1 | 0.1 | 0.1 |
| Catalyst | Carrier resin | EVOLUE SP0540 | LLDPE | | | | |
| MB | | VF120T | EVA | 20 | 20 | 20 | 20 |
| | | TUFTEC N504 | SEBS | 5 | 5 | 5 | 5 |
| | | Diana Process Oil PW-90 | Organic oil | 5 | 5 | 5 | 5 |
| | Hindered phenol-based | IRGANOX 1010 | | 1 | 1 | 3 | |
| | antioxidant | ADK STAB CBA-10 | | 0.5 | 0.5 | 1.5 | |
| | Benzimidazole-based | NOCRAC MBZ | | 8 | 8 | | 12 |
| | antioxidant | | | | | | |
| | Silanol condensation | ADK STAB OT-1 | | 0.06 | 0.05 | 0.05 | 0.05 |
| | catalyst | | | | | | |

| Silane crosslinkable resin | Total content rate of ethylene-based copolymer | | 40 | 40 | 40 | 40 |
|---|---|---|---|---|---|---|
| composition | Substantial content of boehmite | | 0 | 15.9 | 27 | 27 |
| | Substantial content of aluminum hydroxide | | 0 | 14.1 | 3 | 3 |
| | Content of hindered phenol-based antioxidant | | 1.6 | 1.6 | 4.6 | 0 |
| | Content of benzimidazole-based antioxidant | | 8 | 8 | 0 | 12 |
| Evaluation | Appearance characteristics | Surface smoothness | A | A | A | B |
| | | Presence or absence of | A | A | A | A |
| | | lumps | | | | |
| | | Presence or absence of | A | C | A | A |
| | | foaming | | | | |
| | Heat resistance | 10000 Hr heat resistant | 137 | 155 | 137 | 141 |
| | | temperature | | | | |
| | | 40000 Hr heat resistant | 124 | 138 | 124 | 127 |
| | | temperature | | | | |
| | Evaluation of crosslinkability | Heating deformation test | Acceptable | Acceptable | Acceptable | Acceptable |

| | | | | Comparative example | | | |
|---|---|---|---|---|---|---|---|
| | | | | 9 | 10 | 11 | 12 |
| Silanol | Base resin | EVOLUE SP0540 | LLDPE | 20 | 20 | 20 | 20 |
| MB | | VF120T | EVA | 20 | 20 | 20 | 20 |
| | | EPT3092PM | EPDM | 10 | 10 | 10 | 10 |
| | | PB 222A | Random PP | 10 | 10 | 10 | 10 |
| | | TUFTEC N504 | SEBS | 5 | 5 | 5 | 5 |
| | | Diana Process Oil PW-90 | Organic oil | 5 | 5 | 5 | 5 |
| | Boehmite | Boehmite FKB104 | Boehmite | 30 | 30 | 30 | 30 |
| | Inorganic filler other | BF 013 | Aluminum hydroxide | | | | |
| | than boehmite | KISUMA 5 | Magnesium hydroxide | | | | |
| | | Boehmite mixed aluminum hydroxide | | | | | |
| | Hindered phenol-based | IRGANOX 1076 | | 0.1 | 0.1 | 0.1 | 0.1 |
| | antioxidant | | | | | | |
| | lubricant | X-21-3043 | Silicone gum | 2 | 2 | 2 | 2 |
| | Silane coupling agent | KBM-1003 | | 3 | 16 | 3 | 3 |
| | Organic peroxide | PERHEXA 25B | | 0.005 | 0.1 | 0.1 | 0.1 |
| Catalyst | Carrier resin | EVOLUE SP0540 | LLDPE | | | | |
| MB | | VF120T | EVA | 20 | 20 | 20 | 20 |
| | | TUFTEC N504 | SEBS | 5 | 5 | 5 | 5 |
| | | Diana Process Oil PW-90 | Organic oil | 5 | 5 | 5 | 5 |
| | Hindered phenol-based | IRGANOX 1010 | | 1 | 1 | 1 | 1 |
| | antioxidant | ADK STAB CBA-10 | | 0.5 | 0.5 | 0.5 | 0.5 |
| | Benzimidazole-based | NOCRAC MBZ | | 8 | 8 | 8 | 8 |
| | antioxidant | | | | | | |
| | Silanol condensation | ADK STAB OT-1 | | 0.05 | 0.05 | 0.005 | 0.6 |
| | catalyst | | | | | | |

| Silane crosslinkable resin | Total content rate of ethylene-based copolymer | | 40 | 40 | 40 | 40 |
|---|---|---|---|---|---|---|
| composition | Substantial content of boehmite | | 27 | 27 | 27 | 27 |
| | Substantial content of aluminum hydroxide | | 3 | 3 | 3 | 3 |
| | Content of hindered phenol-based antioxidant | | 1.6 | 1.6 | 1.6 | 1.6 |
| | Content of benzimidazole-based antioxidant | | 8 | 8 | 8 | 8 |
| Evaluation | Appearance characteristics | Surface smoothness | A | A | A | B |
| | | Presence or absence of | A | A | A | C |
| | | lumps | | | | |
| | | Presence or absence of | A | C | A | A |
| | | foaming | | | | |
| | Heat resistance | 10000 Hr heat resistant | 147 | 153 | 145 | 146 |
| | | temperature | | | | |
| | | 40000 Hr heat resistant | 132 | 137 | 131 | 131 |
| | | temperature | | | | |
| | Evaluation of crosslinkability | Heating deformation test | Unac- | Acceptable | Unac- | Acceptable |
| | | | ceptable | | ceptable | |

As is clear from the results of Tables 1 and 2, in Comparative Examples 1, 5, 7, and 8 in which the ethylene copolymer, the boehmite, the benzimidazole-based antioxidant, or the hindered phenol-based antioxidant is not contained, the predicted 10000 hour life temperature is lower than 150° C., and high heat resistance cannot be realized.

In addition, in Comparative Examples 4 and 6 in which aluminum hydroxide is excessively contained, foaming at the time of melt-mixing cannot be suppressed, and appearance characteristics are poor. Comparative Example 2 in which the content of boehmite is too low and Comparative Example 3 in which the content of boehmite is too high cannot achieve high heat resistance, and Comparative Example 2 is also inferior in surface smoothness. In Comparative Example 3, 10 parts by mass of aluminum hydroxide was contained, and 90 parts by mass of boehmite was also contained, and thus the influence of foaming of aluminum hydroxide was considered to be relatively small.

In Comparative Examples 9 and 11 in which the content of the organic peroxide or the silanol condensation catalyst is too low, high heat resistance cannot be realized, the heating deformation test is determined to be unacceptable, and sufficient crosslinking cannot be formed. Meanwhile, in Comparative Example 10 in which the content of the silane coupling agent is too high, foaming cannot be suppressed, and appearance characteristics are poor. In addition, in Comparative Example 12 in which the content of the silanol condensation catalyst is too high, generation of lumps cannot be suppressed, appearance characteristics are poor, and high heat resistance cannot be realized.

On the other hand, in all of Examples 1 to 13 in which the boehmite, the silane coupling agent, and the silanol condensation catalyst are contained at a specific ratio, as well as the ethylene copolymer, the hindered phenol-based antioxidant, and the benzimidazole-based antioxidant are contained, and aluminum hydroxide is not contained, appearance characteristics are excellent, and high heat resistance having a predicted 10000 hour life temperature of 150° C. or higher is exhibited. Further, the heating deformation test is determined to be acceptable (sufficient crosslinking is formed). For example, the characteristics required for the coating layer of the insulated crosslinked electric wire are satisfied.

Having described the present invention as related to the embodiment, it is our intention that the present invention not be limited by any of the details of the description, unless otherwise specified, but rather be construed broadly within its spirit and scope as set out in the accompanying claims.

1. A method of producing a heat-resistant silane crosslinked resin formed body comprising subjecting a silane crosslinkable resin composition to silane crosslinking, wherein the silane crosslinkable resin composition contains, with respect to 100 parts by mass of a base resin containing at least one ethylene copolymer of an ethylene-vinyl acetate copolymer or an ethylene-(meth)acrylic acid ester copolymer, 9 to 80 parts by mass of boehmite, 1 to 15 parts by mass of a silane coupling agent graft-bonded to the base resin, 0.01 to 0.5 parts by mass of a silanol condensation catalyst, a hindered phenol-based antioxidant, and a benzimidazole-based antioxidant, but does not contain aluminum hydroxide,
the method comprising the following steps (a), (b), (c), (d), and (e), wherein the hindered phenol-based antioxidant or the benzimidazole-based antioxidant is mixed in at least one of the steps (a) and (b):
Step (a): a step of preparing a silane masterbatch by melt-mixing a part of the base resin, the boehmite, the silane coupling agent having a grafting reaction site capable of being graft-reacted with the base resin, and 0.01 to 0.5 parts by mass of an organic peroxide with respect to 100 mass % of the base resin at a temperature equal to or higher than a decomposition temperature of the organic peroxide;
Step (b): a step of preparing a catalyst masterbatch by melt-mixing a remainder of the base resin and the silanol condensation catalyst;
Step (c): a step of obtaining a silane crosslinkable resin composition by dry blending the silane masterbatch and the catalyst masterbatch;
Step (d): a step of obtaining a formed body by forming the silane crosslinkable resin composition; and
Step (e): a step of obtaining a heat-resistant silane crosslinked resin formed body by bringing the formed body and water into contact with each other.

2. The production method according to claim 1, wherein the hindered phenol-based antioxidant is contained in an amount of 0.5 to 5 parts by mass with respect to 100 parts by mass of the base resin.

3. The production method according to claim 1, wherein the benzimidazole-based antioxidant is contained in an amount of 4 to 12 parts by mass with respect to 100 parts by mass of the base resin.

4. The production method according to claim 1, wherein the ethylene copolymer is contained in a proportion of 10 to 70 mass % in 100 mass % of the base resin.

5. The production method according to claim 1, wherein each of the ethylene copolymers contained in the base resin contains vinyl acetate or (meth)acrylic acid ester in a proportion of 10 to 30 mass % in each of the ethylene copolymers.

6. The production method according to claim 1, wherein the boehmite is contained in an amount of 9 to 50 parts by mass with respect to 100 parts by mass of the base resin.

7. The production method according to claim 1, wherein the base resin contains a styrene-based elastomer and an organic oil.

8. A method of producing a silane crosslinkable resin composition, wherein the silane crosslinkable resin composition contains, with respect to 100 parts by mass of a base resin containing at least one ethylene copolymer of an ethylene-vinyl acetate copolymer or an ethylene-(meth)acrylic acid ester copolymer, 9 to 80 parts by mass of boehmite, 1 to 15 parts by mass of a silane coupling agent graft-bonded to the base resin, 0.01 to 0.5 parts by mass of a silanol condensation catalyst, a hindered phenol-based antioxidant, and a benzimidazole-based antioxidant, but does not contain aluminum hydroxide,
the method comprising the following steps (a), (b), and (c), wherein the hindered phenol-based antioxidant or the benzimidazole-based antioxidant is mixed in at least one of the steps (a) and (b):
Step (a): a step of preparing a silane masterbatch by melt-mixing a part of the base resin, the boehmite, the silane coupling agent having a grafting reaction site capable of being graft-reacted with the base resin, and 0.01 to 0.5 parts by mass of an organic peroxide with respect to 100 mass % of the base resin at a temperature equal to or higher than a decomposition temperature of the organic peroxide;
Step (b): a step of preparing a catalyst masterbatch by melt-mixing a remainder of the base resin and the silanol condensation catalyst; and
Step (c): a step of obtaining a silane crosslinkable resin composition by dry blending the silane masterbatch and the catalyst masterbatch.

9. A heat-resistant silane crosslinked resin formed body produced by the production method according to claim 1.

10. A silane crosslinkable resin composition produced by the production method according to claim 8.

11. A wiring material comprising a coating layer on an outer periphery of a conductor, wherein the coating layer is a layer of the heat-resistant silane crosslinked resin formed body according to claim 9.

12. The wiring material according to claim 11, wherein the wiring material is a heat-resistant electric wire or cable.
